(19) United States
(12) Patent Application Publication
(10) Pub. No.: US 2005/0015711 A1
(43) Pub. Date: Jan. 20, 2005

(54) Workflow management apparatus and method

(76) Inventors: Kensaku Yamamoto, Saitama (JP); Katsumi Kanasaki, Tokyo (JP); Satosi Imago, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/890,105

(22) Filed: Jul. 14, 2004

(30) Foreign Application Priority Data
Jul. 16, 2003 (JP) 2003-197852
Jun. 29, 2004 (JP) 2004-191381

(51) Int. Cl. G06F 17/00

(52) U.S. Cl. 715/500

(57) ABSTRACT

A workflow management apparatus for managing one or more document-related workflows is disclosed. In the workflow management apparatus, the document-related workflows are managed by an object-oriented model that includes a process instance class defining one of the document-related workflows, an activity instance class defining one of steps of the document-related workflows, and a form instance class defining one of user interfaces employed in executing the steps of the document-related workflows.

### BACKGROUND OF THE INVENTION

1. Field of the Invention

The present invention generally relates to a workflow management apparatus, a workflow management method, and a recording medium on which is recorded a program for causing a computer to execute such a workflow management method.

2. Description of the Related Art

In these years, a workflow system has become well known that manages and automates a flow of documents or information from one person to another, when multiple persons work via a network, so as to facilitate their work. Such a workflow system is disclosed, for instance, in: “Expanding Workflow Management System: 1,” by Haruo Hayami, IPSJ (Information Processing Society of Japan) Magazine, Vol. 39, No. 11, pp.1160-1165 (1998); “Expanding Workflow Management System: 2,” by Haruo Hayami, Toshiaki Sakaguchi, and Ryoichi Shibuya, IPSJ Magazine, Vol. 39, No. 12, pp.1258-1263 (1998); “Expanding Workflow Management System: 3,” by Haruo Hayami, Ryoichi Shibuya, Takao Suzuki, Junichi Ikoma, Yosuke Terashita, Naoki Ueno, Satoshi Kaneko, and Kiyoshi Hayashi, IPSJ Magazine, Vol. 40, No. 5, pp.507-513 (1999); “Standards,”<http://www.wfmc.org/standards/standards.htm>(search date: Jul. 3, 2003); “Workflow Management Coalition, The Workflow Reference Model,”<http://www.wfmc.org/standards/docs/tc003v11.pdf>(search date: Jul. 3, 2003); and “Workflow Management Coalition, Terminology & Glossary,”<http://www.wfmc.org/standards/docs/TC-1011_term_glossary_v3.pdf>(search date: Jul. 3, 2003).

However, in a general workflow system, there is a problem in that in terms of steps composing a workflow, only one user interface (UI) is employable for the implementation of the steps.

Accordingly, when the implementation environments of the participant terminals of the workflow vary from personal computers (PCs) to cellular phones and below-described multi-function printers (MFPs), participants are prevented from using an optimum UI in accordance with the execution environments at the time of executing the steps of the workflow.

### SUMMARY OF THE INVENTION

Accordingly, it is a general object of the present invention to provide a workflow management apparatus and method in which the above-described disadvantage is eliminated.

A more specific object of the present invention is to provide a workflow management apparatus and method that can form a workflow so that multiple UIs are employable in executing the steps of the workflow.

Another more specific object of the present invention is to provide a recording medium on which is recorded a program for causing a computer to execute such a workflow management method.

One or more of the above objects of the present invention are achieved by a workflow management apparatus for managing one or more document-related workflows, wherein the document-related workflows are managed by an object-oriented model that includes: a process instance class defining one of the document-related workflows; an activity instance class defining one of the steps of the document-related workflows; and a form instance class defining one of user interfaces employed in executing the steps of the document-related workflows.

One or more of the above objects of the present invention are also achieved by a method of managing one or more document-related workflows, including the steps of: (a) selecting the template of a user interface in response to a request from the terminal of a participant in the document-related workflows, the user interface being employed when the participant executes one of the steps of the document-related workflows; and (b) transmitting the template of the user interface selected in step (a) to the terminal of the participant.

One or more of the above objects of the present invention are also achieved by a computer-readable recording medium storing a program for causing a computer to execute a method of managing one or more document-related workflows, the method including the steps of: (a) selecting the template of a user interface in response to a request from the terminal of a participant in the document-related workflows, the user interface being employed when the participant executes one of the steps of the document-related workflows; and (b) transmitting the template of the user interface selected in step (a) to the terminal of the participant.

According to the present invention, a workflow can be configured so that multiple user interfaces may exist for the steps of the workflow when the steps are executed.

### BRIEF DESCRIPTION OF THE DRAWINGS

Other objects, features and advantages of the present invention will become more apparent from the following detailed description when read in conjunction with the accompanying drawings, in which:

FIG. 1 is a concept diagram showing a document flow system according to a first embodiment of the present invention;

FIG. 2 is a block diagram showing a hardware configuration of a document flow server according to the first embodiment of the present invention;

FIG. 3 is a block diagram showing a functional configuration of an MFP according to the first embodiment of the present invention;

FIG. 4 is a block diagram showing a configuration in the case of including the function of the document flow server in the MFP according to the first embodiment of the present invention;

FIG. 5 is a block diagram showing a configuration in the case of including the function of a document flow management tool in the MFP according to the first embodiment of the present invention;

FIG. 6 is a block diagram showing a hardware configuration of the MFP according to the first embodiment of the present invention;

FIG. 7 is a block diagram showing a functional configuration of a document flow service according to the first embodiment of the present invention;

FIG. 8 is a diagram showing a first example of the relationship among classes representing a document flow according to the first embodiment of the present invention;

FIG. 9 is a diagram showing a second example of the relationship among the classes representing the document flow according to the first embodiment of the present invention;

FIG. 10 is a diagram for illustrating a first configuration of a process template according to the first embodiment of the present invention;

FIG. 11 is a diagram for illustrating a process instance corresponding to the process template of FIG. 10 according to the first embodiment of the present invention;

FIG. 12 is a flowchart for illustrating the flow of activities shown in FIG. 11 according to the first embodiment of the present invention;

FIG. 13 is a diagram for illustrating a second configuration of the process template according to the first embodiment of the present invention;

FIG. 14 is a diagram for illustrating a process instance corresponding to the process template of FIG. 13 according to the first embodiment of the present invention;

FIG. 15 is a flowchart for illustrating activities shown in FIG. 14 according to the first embodiment of the present invention;

FIG. 16 is a diagram for illustrating a third configuration of the process template according to the first embodiment of the present invention;

FIG. 17 is a diagram for illustrating a fourth configuration of the process template according to the first embodiment of the present invention;

FIG. 18 is a diagram for illustrating the relationship among a work list, a work item, and an activity according to the first embodiment of the present invention;

FIG. 19 is a sequence diagram of process definition according to the first embodiment of the present invention;

FIG. 20 is a sequence diagram of process starting according to the first embodiment of the present invention;

FIG. 21 is a sequence diagram for illustrating a first work item execution sequence according to the first embodiment of the present invention;

FIG. 22 is a diagram for illustrating a configuration of the process template according to a second embodiment of the present invention;

FIG. 23 is a diagram for illustrating a configuration of the process instance according to the second embodiment of the present invention;

FIG. 24 is a sequence diagram of process starting according to a third embodiment of the present invention;

FIG. 25 is a diagram showing an example of the relationship among the classes representing the document flow according to a fourth embodiment of the present invention;

FIG. 26 is a sequence diagram showing the sequence of registering a process instance as a process template according to the fourth embodiment of the present invention;

FIG. 27 is a sequence diagram showing the sequence of registering an activity instance as an activity template according to the fourth embodiment of the present invention;

FIG. 28 is a sequence diagram showing the sequence of registering a form instance as a form template according to the fourth embodiment of the present invention;

FIG. 29 is a sequence diagram showing the sequence of registering a document instance as a document template according to the fourth embodiment of the present invention;

FIG. 30 is a diagram for illustrating a first configuration of the process template according to the fourth embodiment of the present invention;

FIG. 31 is a diagram for illustrating a second configuration of the process template according to the fourth embodiment of the present invention;

FIG. 32 is a diagram for illustrating a third configuration of the process template according to the fourth embodiment of the present invention;

FIG. 33 is a diagram for illustrating a fourth configuration of the process template according to the fourth embodiment of the present invention;

FIG. 34 is a sequence diagram of process starting according to the fourth embodiment of the present invention;

FIG. 35 is a sequence diagram for illustrating a work item execution sequence according to the fourth embodiment of the present invention; and

FIG. 36 is a sequence diagram of process starting according to a fifth embodiment of the present invention.

### DETAILED DESCRIPTION OF THE PREFERRED EMBODIMENTS

A description is given below, with reference to the accompanying drawings, of embodiments of the present invention. In the following description, a workflow relating to a document may also be referred to as a document flow.

[First Embodiment]

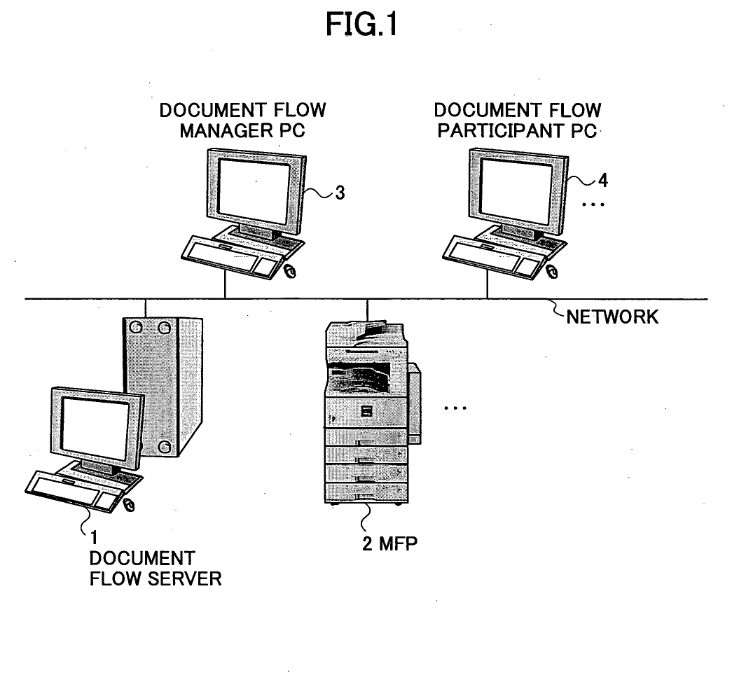

FIG. 1 is a concept diagram showing a document flow system according to a first embodiment of the present invention. As shown in FIG. 1, the document flow system includes a document flow server 1, at least one MFP 2, a document flow manager PC 3, and at least one document flow participant PC 4, which are connected via a network.

The document flow server 1 includes a below-described document flow service 20, which manages, for instance, a process and a document relating to a document flow.

The document flow system manager PC 3 includes a document flow management tool for a document flow manager. For instance, the document flow manager, using the document flow management tool, queries the document flow server 1 for the status of each process so as to manage the process and create the template of the process. The document flow management tool may be a Web browser or a dedicated application.

The document flow participant PC 4 includes a tool having a GUI used by a document flow participant. For instance, the document flow participant, using the tool, examines and/or approves a document that is the current object of the document flow, and enters a comment on the document. The tool may be a Web browser or a dedicated application.

A program having the same function as the tool included in the document flow participant PC 4 may be installed in the MFP 2. Hereinafter, the tool having the GUI used by the document flow participant and the program installed in the MFP 2 may also be referred to simply as document flow clients.

The document flow system is not always required to include the MFP 2. For instance, the document flow system may be composed of the document flow server 1, the document flow manager PC 3, and the document flow participant PC or PCs 4.

The document flow system is not always required to include the document flow participant PC 4, either. For instance, the document flow system may be composed of the document flow server 1, the document flow manager PC 3, and the MFP or MFPs 2 each including the GUI used by the document flow participant.

In FIG. 1, the document flow participant PC 4 may be replaced by a mobile terminal such as a cellular phone.

In the following description, it is assumed for simplification of description that the document flow system includes the MFP 2, the document flow manager PC 3, and the document flow participant PC 4 as shown in FIG. 1 unless otherwise specified.

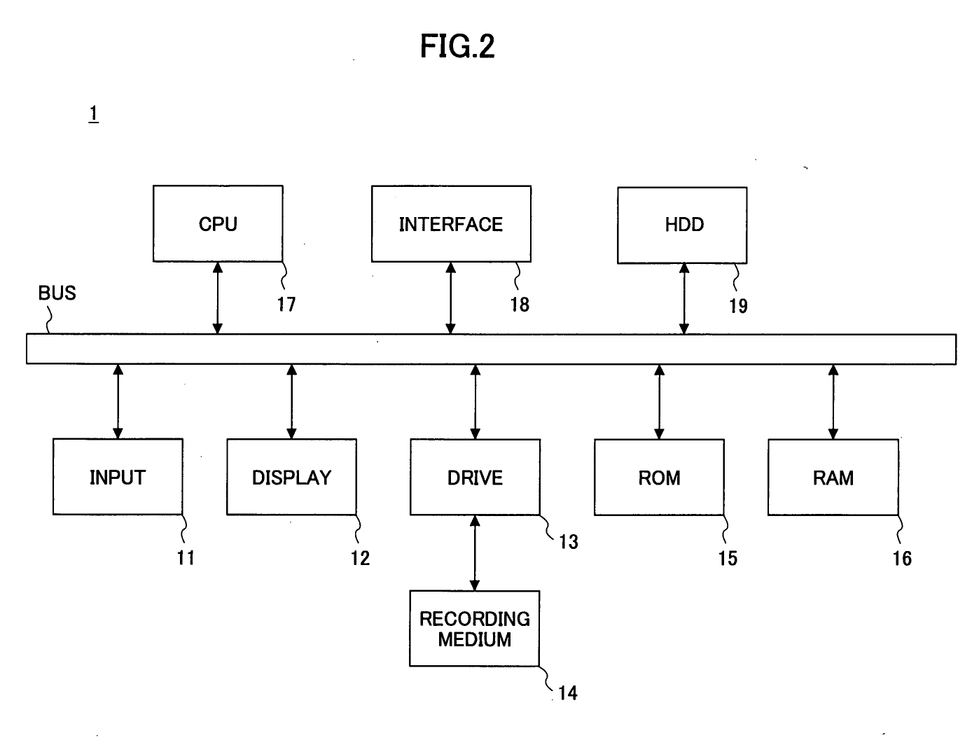

Next, a description is given, with reference to FIG. 2, of the hardware configuration of the document flow server 1. FIG. 2 is a block diagram showing a hardware configuration of the document flow server 1.

Referring to FIG. 2, the document flow server 1 includes an input unit 11, a display unit 12, a drive unit 13, a read-only memory (ROM) 15, a random access memory 16, a central processing unit (CPU) 17, an interface unit 18, and a hard disk drive (HDD) 19, which are connected to one another by a bus.

The input unit 11 is composed of a keyboard and a mouse operated by a user of the document flow server 1. The input unit 11 is used to input various operation signals to the document flow server 1.

The display unit 12, which is composed of a display used by the user of the document flow server 1, displays a variety of information items.

The interface unit 18 is an interface connecting the document flow server 1 to the network.

A program corresponding to the document flow service 20 may be provided to the document flow server 1 through a recording medium 14 such as a CD-ROM, or downloaded to the document flow server 1 via the network. The recording medium 14 is set in the drive unit 13 so that the program is installed in the HDD 19 from the recording medium 14 via the drive unit 13.

The ROM 15 stores data. The RAM 16 stores the program read out from the HDD 19 at the time of activation of the document flow server 1. The CPU 17 performs processing in accordance with the program stored in the RAM 16.

In addition to the program corresponding to the document flow server 20, the HDD 19 stores, for instance, a process template, an activity template, a form template, a process instance, an activity instance, a form instance, a work item, a work list, and a document instance.

The document flow manager PC 3, the document flow participant PC 4, a below-described document management server, and a below-described translation server have the same hardware configuration as the document flow server 1 shown in FIG. 2.

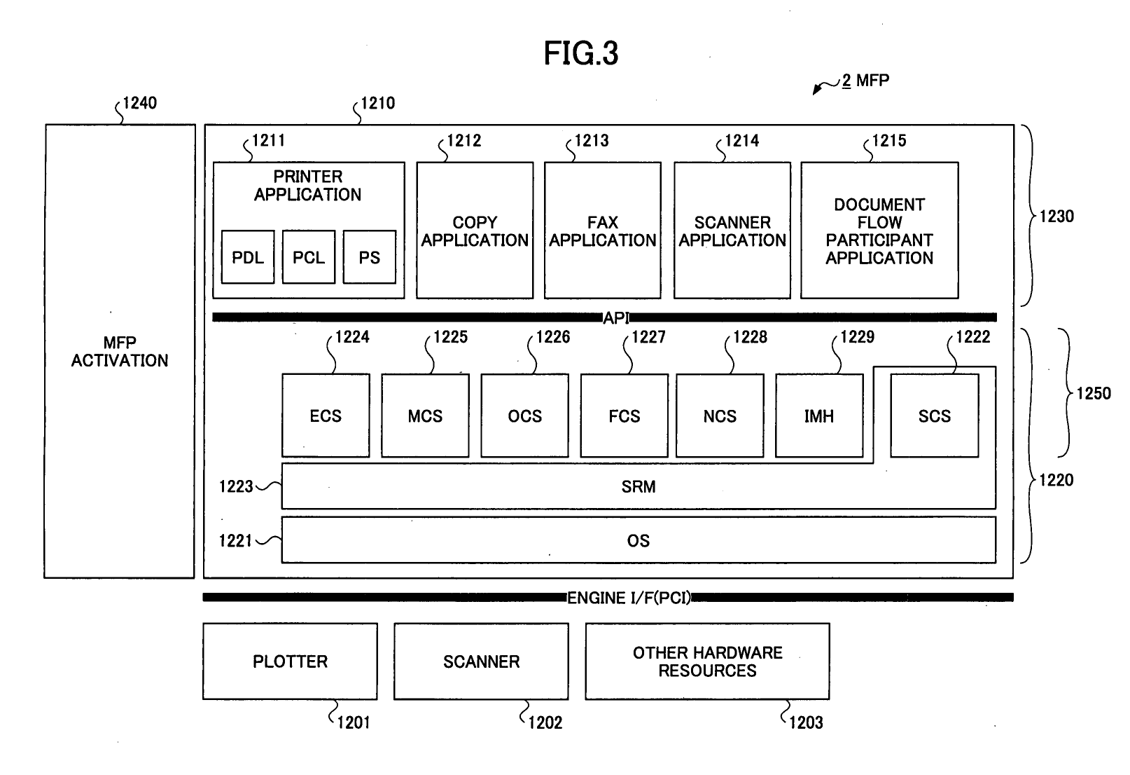

Next, a description is given, with reference to FIGS. 3 through 6, of the functional configuration and the hardware configuration of the MFP 2.

FIG. 3 is a block diagram showing a functional configuration of the MFP 2.

The MFP 2 includes a plotter 1201, a scanner 1202, other hardware resources 1203 including a facsimile machine, a software group 1210 including a platform 1220 and applications 1230, and an MFP activation part 1240.

When the MFP 2 is turned on, the MFP activation part 1240 is first started to activate the platform 1220 and the applications 1230.

The platform 1220 includes a control service 1250, a system resource manager (SRM) 1223, and an OS 1221. The control service 1250 interprets a processing request from the applications 1230 and generates a request to obtain a hardware resource (a hardware resource obtaining request). The SRM 1223 manages one or more hardware resources and arbitrates between hardware resource obtaining requests from the control service 1250.

The control service 1250 includes multiple service modules, which are a system control service (SCS) 1222, an engine control service (ECS) 1224, a memory control service (MCS) 1225, an operations panel control service (OCS) 1226, a facsimile control service (FCS) 1227, a network control service (NCS) 1228, and an imaging memory handler (IMH) 1229.

The OS 1221, which is an operating system such as UNIX®, executes the software programs of the platform 1220 and the applications 1230 in parallel as processes.

The SRM 1223 perform system control and resource management in cooperation with the SCS 1222. The SRM 1223 performs arbitration and execution control according to requests from an upper layer for the use of hardware resources such as an engine part (such as the scanner 1202 or the plotter 1201), a memory, an HDD file, and a host I/O (a Centronics I/F, a network I/F, an IEEE 1394 I/F, or an RS-232-C I/F, for instance).

The SCS 1222 perform multiple functions such as application management, operation part control, system screen display (for instance, display of a job list screen and a counter display screen), LED display, resource management, and interrupting application control.

The ECS 1224 controls the engine part including the plotter 1201, the scanner 1202, and the other hardware resources 1203. For instance, the ECS 1224 reads images, performs printing, makes state notifications, and makes jam recoveries.

The MCS 1225 performs memory control. More specifically, the MCS 1225 obtains and releases image memory, uses an HDD, and compresses and decompresses image data, for instance.

The OCS 1226 controls an operations panel that serves as an information transmission part between an operator and main body control. For instance, the OCS 1226 notifies the main body control of the key operation events of the operator, provides a library function for each application to construct a GUI, manages the constructed GUI information application by application, and performs display reflection onto the operations panel.

The FCS 1227 provides an application program interface (API) for facsimile transmission to and reception from each application layer of a system controller using a PSTN or ISDN network, registration and citation of a variety of facsimile data managed in a backup SRAM (BKM), reading of facsimile communications, printing of received facsimile communications, and multi-function-related transmission and reception.

The NCS 1228 is a module group for providing applications requiring network I/O with services that can be used in common. The NCS 1228 mediates in distributing the data received from the network in accordance with each protocol among the applications and transmitting data from the applications to the network.

The IMH 1229 maps image data in a virtual memory region into a physical memory. The IMH 1229 makes a system call in response to the activation of a process. Then, the IMH 1229 maps a virtual memory region for the process, and releases the virtual memory region when the process is completed.

The applications 1230 includes a printer application 1211 for a printer including a page-description language (PDL), a printer control language (PCL), and PostScript (PS), a copy application 1212 for a copier, a fax application 1213 for a facsimile machine, a scanner application 1214 for a scanner, and a document flow participant application 1215 that is an application for the document flow participant.

For instance, the document flow participant application 1215 corresponds to the program providing the same function as the tool included in the document flow participant PC 4 as described with reference to FIG. 1.

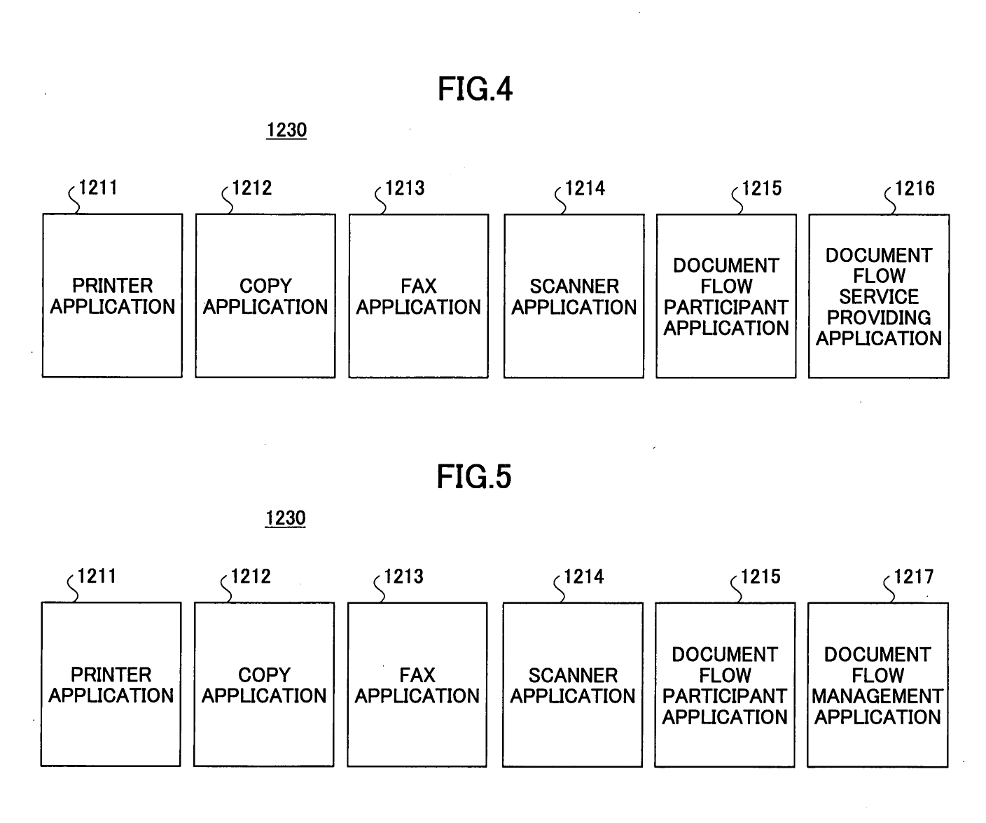

The function of the document flow server 1 may be included in the MFP 2. FIG. 4 is a block diagram showing a configuration in the case of including the function of the document flow server 1 in the MFP 2.

Referring to FIG. 4, the applications 1230 of the MFP 2 include a document flow service providing application 1216 providing the function of the document flow server 1.

Alternatively, the function of the document flow management tool included in the document flow manager PC 3 may be included in the MFP 2. FIG. 5 is a block diagram showing a configuration in the case of including the function of the document flow management tool in the MFP 2.

Referring to FIG. 5, the applications 1230 of the MFP 2 include a document flow management application 1217 providing the function of the document flow management tool.

In the following description, it is assumed that the MFP 2 has the functional configuration as shown in FIG. 3 unless otherwise specified.

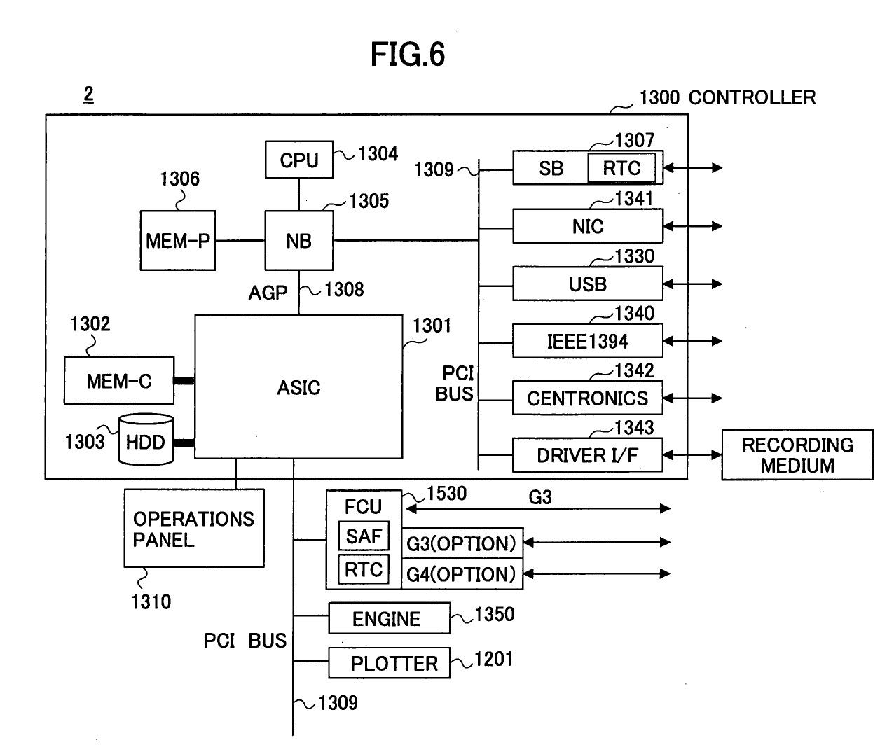

FIG. 6 is a block diagram showing a hardware configuration of the MFP 2.

Referring to FIG. 6, the MFP 2 has a configuration where an operations panel 1310, a facsimile control unit (FCU) 1530, an engine part 1350 (to which, for instance, the scanner 1202 is connected), and the plotter 1201 are connected to an application specific integrated circuit (ASIC) 1301 of a controller 1300 via a peripheral component interconnect (PCI) bus 1309 and the like.

In the controller 1300, a local memory (MEM-C) 1302 and a hard disk drive (HDD) 1303 are connected to the ASIC 1301, and the ASIC 1301 and a CPU 1304 are connected via a Northbridge (NB) 1305 of a CPU chipset.

The ASIC 1301 and the NB 1305 are connected not by a mere PCI bus but by an accelerated graphics port (AGP) 1308.

The CPU 1304 performs overall control of the MFP 2. Specifically, the CPU 1304 causes the SCS 1222, the SRM 1223, the ECS 1224, the MCS 1225, the OCS 1226, the FCS 1227, the NCS 1228, and the IMH 1229 forming the platform 1220 to be activated and executed as processes on the OS 1221. Further, the CPU 1304 causes the printer application 1211, the copy application 1212, the fax application 1213, the scanner application 1214, and the document flow participant application 1215 to be activated and executed.

The NB 1305 is a bridge for connecting the CPU 1304 to a system memory (MEM-P) 1306, a Southbridge (SB) 1307, a network interface card (NIC) 1341, a universal serial bus (USB) 1330, an IEEE 1394 device 1340, a Centronics device 1342, a driver I/F 1343, and the ASIC 1301.

The system memory (MEM-P) 1306 is used as memory for image drawing of the MFP 2. The SB 1307 is a bridge for connecting the NB 1305 with a PCI bus, a ROM, and peripheral devices. The local memory (MEM-C) 1302 is used as an image buffer for copying and a code buffer. The ASIC 1301 is an IC for image processing including a hardware element for image processing.

The driver I/F 1343 is an interface used to read a program or an application from an inserted recording medium storing the program or the application and install the read program or application in the MFP 2. The recording medium may be, for instance, an SD memory card, a smart medium, a multimedia card, or a CompactFlash®.

The HDD 1303 stores image data, programs, font data, and documents. The operations panel 1310 is an operation part that receives inputs from the operator and displays information to the operator.

The ASIC 1301 includes a RAM interface for connecting the local memory (MEM-C) 1302 and a hard disk interface for connecting the HDD 1303. When image data is input to or output from these memory parts, the target or source of the image data is switched to the RAM interface or the hard disk interface.

The AGP 1308 is a bus interface for a graphics accelerator card, which has been proposed to accelerate graphics processing. The AGP 1308 directly accesses the system memory (MEM-P) 1306 at high throughput so that the graphics accelerator card operates at high speed.

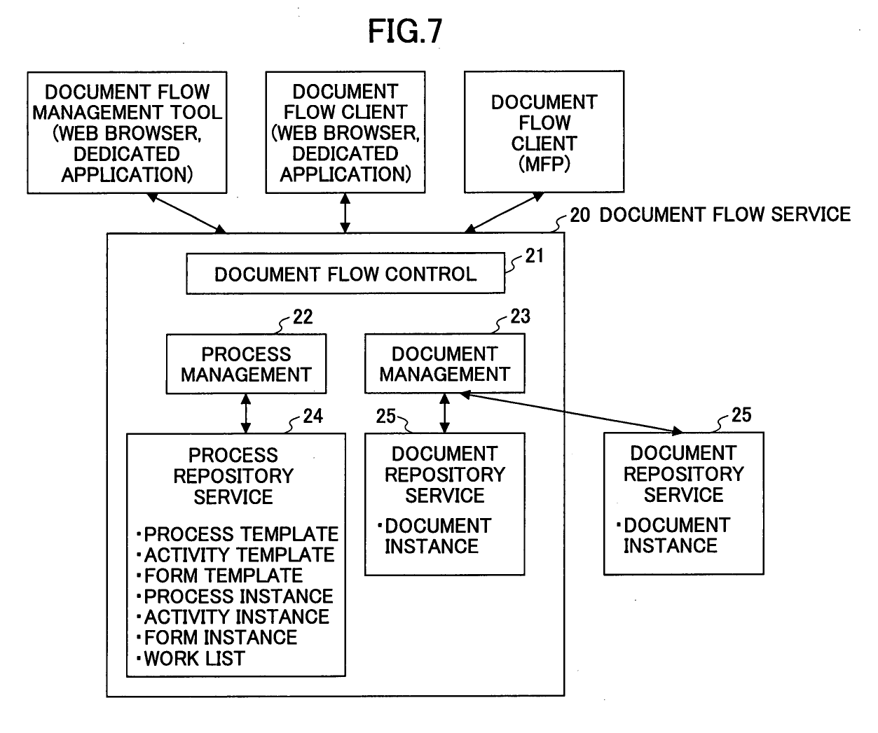

Next, a description is given, with reference to FIG. 7, of the functional configuration of the document flow service 20. FIG. 7 is a block diagram showing a functional configuration of the document flow service 20.

Referring to FIG. 7, the document flow service 20 included in the document flow server 1 includes a document flow control part 21, a process management part 22, a document management part 23, a process repository service 24, and a document repository service 25.

The document flow control part 21 performs processing in response to a request from the document flow management tool included in the document flow manager PC 3, a request from the tool having the GUI included in the document flow participant PC 4, and/or the program installed in the MFP 2.

The process management part 22 manages the process repository service 24. The document management part 23 manages the document repository service 25.

The process repository service 24 retains a process template and a process instance (described below). The process template includes an activity template and a form template. The process instance includes an activity instance and a form instance.

The document repository service 25 retains a document that is the object of the document flow. The document repository service 25 may be included in an apparatus other than the document flow server 1, such as a document management server.

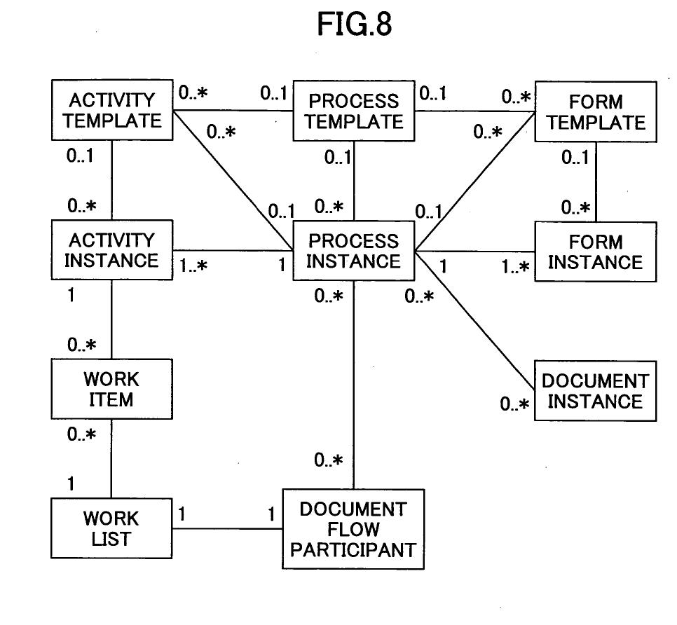

Next, a description is given, with reference to FIG. 8, of the relationship among the classes representing the document flow included in the document flow service 20. FIG. 8 is a diagram showing a first example of this relationship according to this embodiment.

As shown in FIG. 8, the classes representing the document flow include a process template class, an activity template class, a form template class, an activity instance class, a process instance class, a form instance class, a work item class, a work list class, a document instance class, and a document flow participant class.

The process template class retains definitions relating to a process. The process instance class represents a single process. The process refers to, for instance, a flow of document-related work.

The activity template class represents each step forming the process template. Hereinafter, each step forming the document flow may also be referred to as an activity. The activity instance class represents a single activity.

The form template class retains forms defined for the process template. The forms refer to, for instance, user interfaces for participants in the document flow. The form instance class represents a single form.

The work item class retains an activity to be executed by a participant in the document flow at a certain point. Hereinafter, such an activity may also be referred to as a work item. However, an activity without user intervention cannot be a work item.

The work list class retains a list of work items. The document instance class represents a single document to be the center of the document flow. The document flow participant class represents the participant in the document flow.

As shown in FIG. 8, with the form template class and/or the form instance class, the forms of the GUIs relating to the workflow system and the forms of printing and/or reading the workflow-related document can be unitarily managed, and the development of the workflow system and/or definitions relating to the workflow, such as the creation of the process template, can be made with efficiency.

For instance, as described below, the forms of the GUIs for the participants in the document flow can be defined in form templates. The form of printing the document flow-related document may be defined in a form template. The form of reading the document flow-related document may be defined in a form template. For instance, by defining the form of reading the document flow-related document in a form template, information written in a predetermined position on the read document can be processed as information of a specific meaning.

Further, as shown in FIG. 8, the multiplicity between the process instance class and the form instance class is greater than or equal to 1:1, and the multiplicity between the process instance class and the activity instance class is greater than or equal to 1:1. Accordingly, for instance, multiple forms may exist, viewing from the activity side.

Accordingly, as described below, each participant in the document flow can execute the activity using an optimum form selected by the document flow service 20 or selected by the participant from those presented by the document flow service 20.

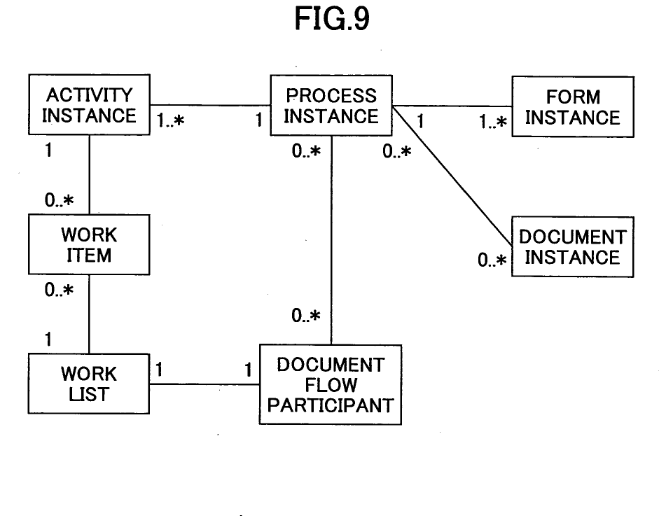

A description is further given, with reference to FIG. 9, of the relationship among the classes representing the document flow included in the document flow service 20. FIG. 9 is a diagram showing a second example of the relationship according to this embodiment.

In contrast to the relationship shown in FIG. 8, the relationship of FIG. 9 lacks the activity template, process template, and form template classes. The document flow service 20 may be configured using the classes shown in FIG. 9. In the following description, however, it is assumed for simplification of description that the relationship among classes representing the document flow is defined as shown in FIG. 8 unless otherwise specified.

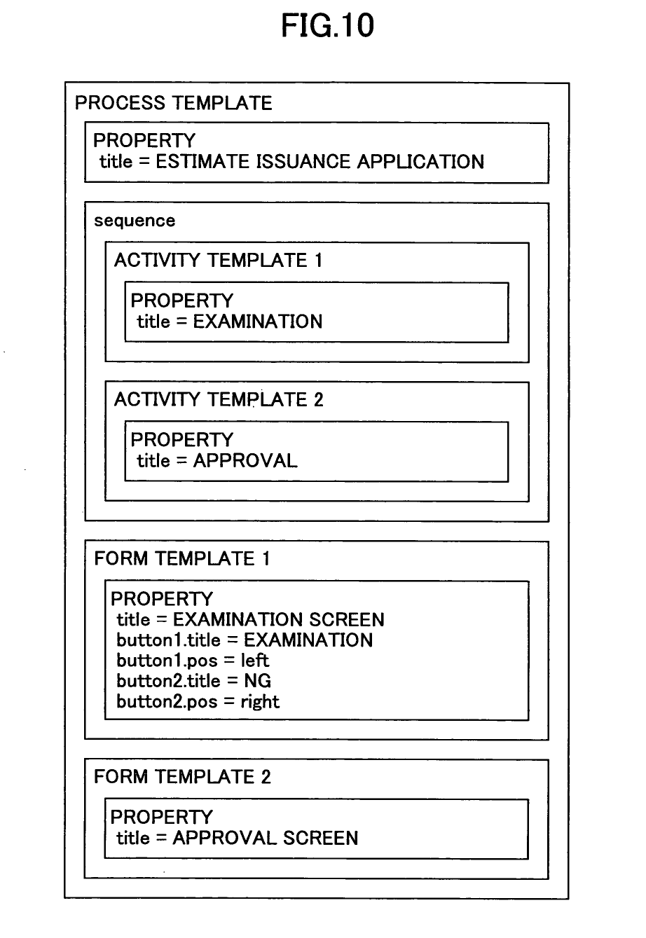

Next, a description is given, with reference to FIG. 10, of the process template. FIG. 10 is a diagram for illustrating a first configuration of the process template.

In the process template of FIG. 10, ACTIVITY TEMPLATE 1 and ACTIVITY TEMPLATE 2 are included in information item “sequence,” defining that the activity of examination and the activity of approval are executed in sequence. Further, the process template of FIG. 10 includes FORM TEMPLATE 1 and FORM TEMPLATE 2. For instance, FORM TEMPLATE 1 defines the form of a screen for examination, and FORM TEMPLATE 2 defines the form of a screen for approval. That is, in the case of FIG. 10, FORM TEMPLATE 1 and FORM TEMPLATE 2 include basic data for creating the screens.

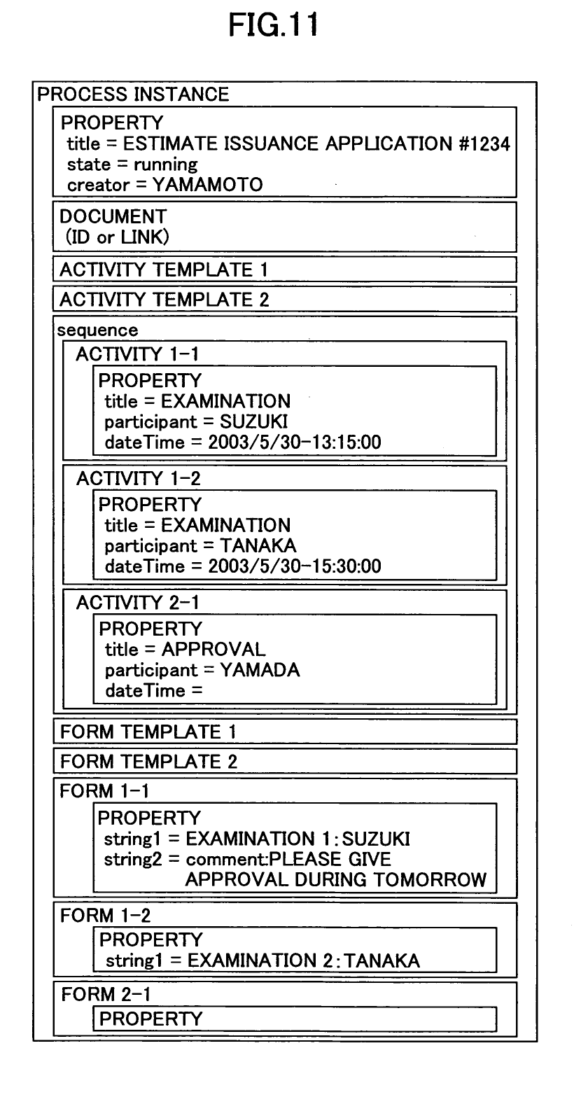

Next, a description is given, with reference to FIG. 11, of the process instance corresponding to the process template of FIG. 10. FIG. 11 is a diagram for illustrating the process instance corresponding to the process template of FIG. 10.

In contrast to the process template of FIG. 10, in the process instance of FIG. 11, a number is added to “title” as a property, and a participant in the document flow who has created the process instance is added as a creator, for instance.

The process instance retains information relating to the actual document, which is an estimate issuance application in the case of FIG. 11. The document-related information may be the ID of the document or link information with respect to the document.

As shown in FIG. 11, the process instance includes a copy of the entities of the activity templates so as to prevent the process from being affected even if the definition of the process is changed while the process is in progress.

In the process instance shown in FIG. 11, ACTIVITY 1-1(hereinafter also referred to simply as A1-1), ACTIVITY 1-2(hereinafter also referred to simply as A1-2), and ACTIVITY 2-1(hereinafter also referred to simply as A2-1) are included as activity instances in information item “sequence.” ACTIVITY 1-1 and ACTIVITY 1-2 are created from ACTIVITY TEMPLATE 1 and ACTIVITY 2-1 is created from ACTIVITY TEMPLATE 2. In the case of FIG. 11, two examinations are made in sequence, and thereafter, an approval is given.

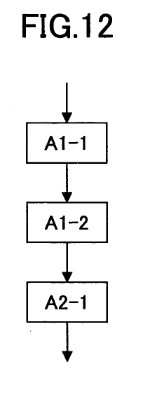

The flow of the activities shown in FIG. 11 is described with reference to FIG. 12. FIG. 12 is a flowchart for illustrating the flow of the activities shown in FIG. 11. As shown in FIG. 12, ACTIVITY 1-1 and ACTIVITY 1-2 are processed in series, and ACTIVITY 2-1 is processed last.

Further, as shown in FIG. 11, the process instance includes a copy of the entities of the form templates so as to prevent the process from being affected even if the definition of the process is changed while the process is in progress.

The process instance shown in FIG. 11 includes FORM 1-1, FORM 1-2, and FORM 2-1 as form instances. FORM 1-1 and FORM 1-2 are created from FORM TEMPLATE 1, and FORM 2-1 is created from FORM TEMPLATE 2.

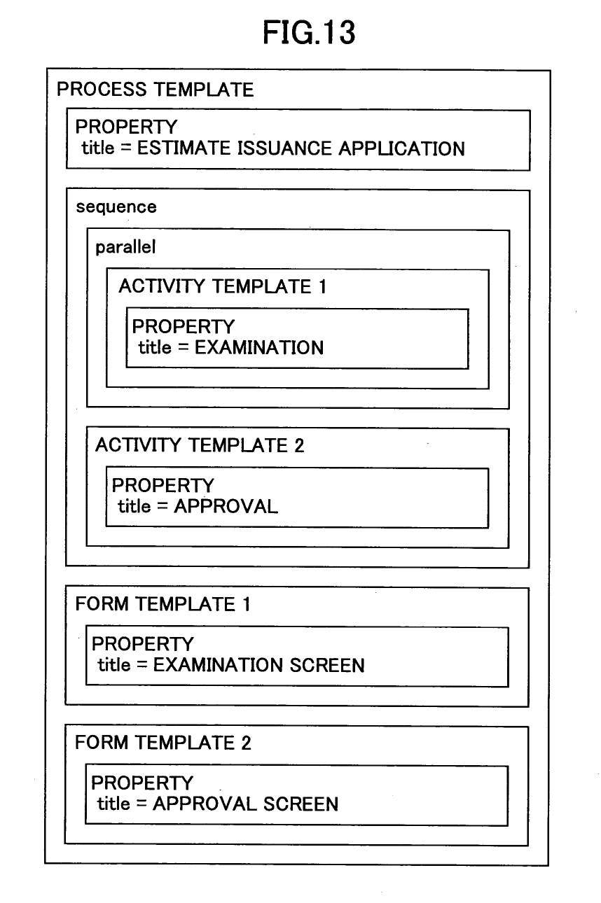

A description is further given, with reference to FIG. 13, of the process template. FIG. 13 is a diagram for illustrating a second configuration of the process template according to this embodiment.

In contrast to the process template of FIG. 10, the process template of FIG. 13 includes ACTIVITY TEMPLATE 1 in information item “parallel.”

In the case of the process template of FIG. 13, examinations can be made in parallel as described below.

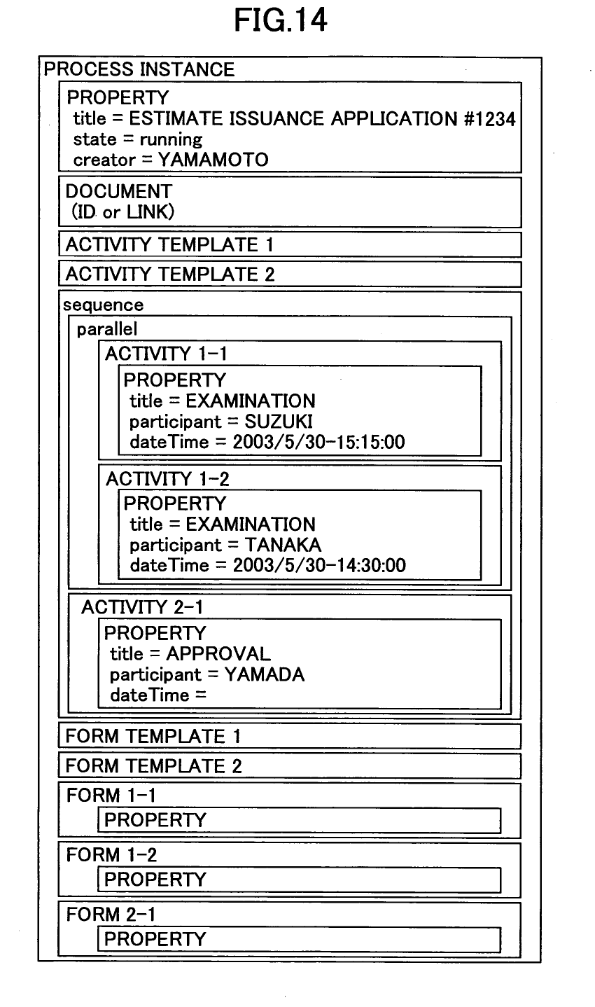

Next, a description is given, with reference to FIG. 14, of the process instance corresponding to the process template of FIG. 13. FIG. 14 is a diagram for illustrating the process instance corresponding to the process template of FIG. 13.

In contrast to the process instance of FIG. 11, the process instance of FIG. 14 includes the ACTIVITY 1-1 and ACTIVITY 1-2 in information item “parallel.” ACTIVITY 1-1 and ACTIVITY 1-2 are created from ACTIVITY TEMPLATE 1. In the case of FIG. 14, examinations are made in parallel, and thereafter, an approval is given.

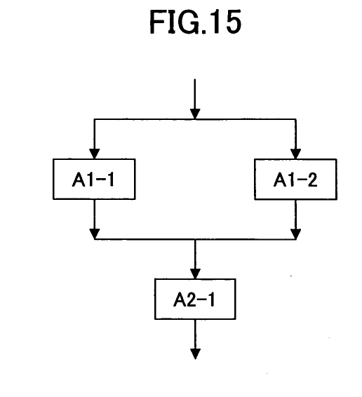

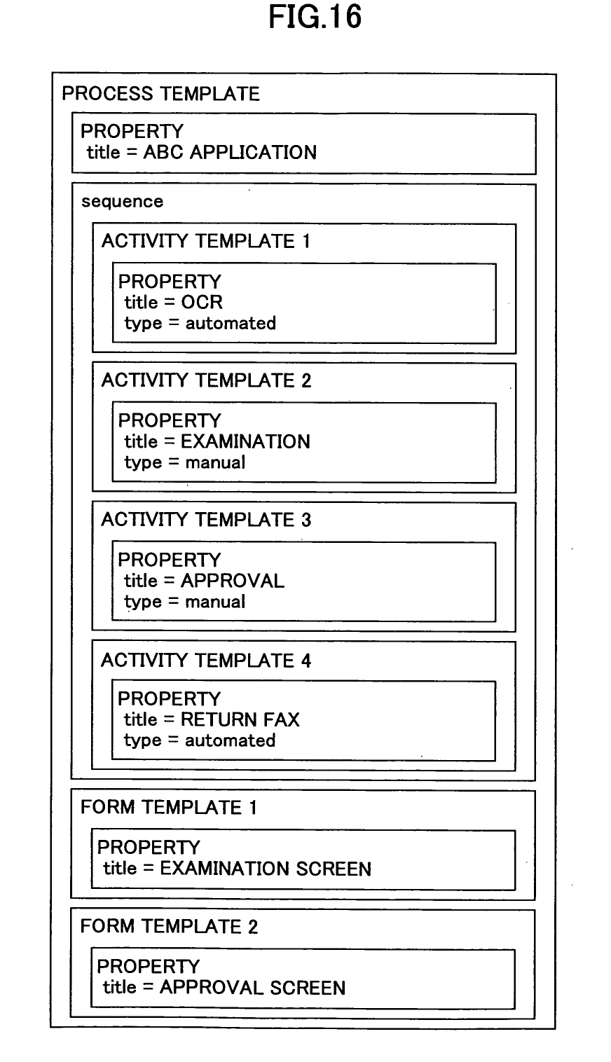

The flow of the activities shown in FIG. 14 is described with reference to FIG. 15. FIG. 15 is a flowchart for illustrating the activities shown in FIG. 14. As shown in FIG. 15, ACTIVITY 1-1 and ACTIVITY 1-2 are processed in parallel, and ACTIVITY 2-1 is processed last.

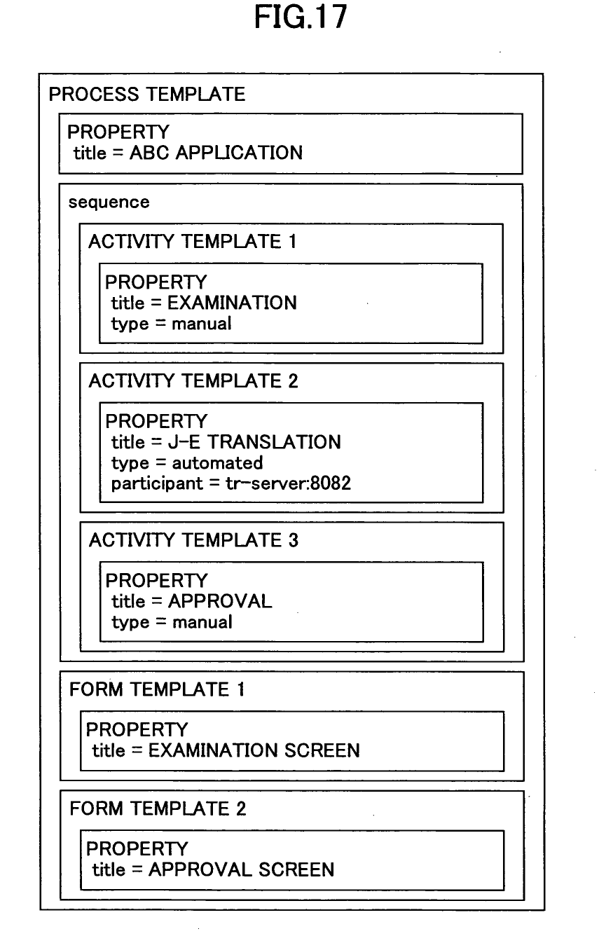

Next, a description is given, with reference to FIG. 16, of the case where a process including a step performed by an apparatus is defined in the process template. FIG. 16 is a diagram for illustrating a third configuration of the process template according to this embodiment.

In contrast to the configurations of the process template shown in FIGS. 10 and 13, a process including steps performed by apparatuses is defined in the process template of FIG. 16.

For instance, an activity executed by an optical character reader (OCR) is defined in ACTIVITY TEMPLATE 1. Further, an activity executed by a facsimile machine is defined in ACTIVITY TEMPLATE 4.

For instance, the MFP 2 reads the document relating to the document flow based on the activity generated based on ACTIVITY TEMPLATE 1 shown in FIG. 16. Further, the MFP 2 returns the examined and approved document by facsimile to a user who has registered the document with the document flow and/or applied for the examination and approval of the document in the document flow, based on the activity generated based on ACTIVITY TEMPLATE 4 shown in FIG. 16.

As shown in FIG. 16, an activity executed by an apparatus can be defined in the process template.

Next, a description is given, with reference to FIG. 17, of the case where a process including a step performed by a service is defined in the process template. FIG. 17 is a diagram for illustrating a fourth configuration of the process template according to this embodiment.

In contrast to the configurations of the process template shown in FIGS. 10 and 13, a process including a step performed by a service is defined in the process template of FIG. 17.

For instance, an activity executed by a service doing a translation from Japanese into English (a Japanese-English or J-E translation service) is defined in ACTIVITY TEMPLATE 2.

For instance, the Japanese-English translation service, which may be included in a server (a translation server) translates the examined document relating to the document flow from Japanese into English based on the activity generated based on ACTIVITY TEMPLATE 2 shown in FIG. 17.

The port number of the translation server is written as “participant” in the property of ACTIVITY TEMPLATE 2 shown in FIG. 17.

As shown in FIG. 17, an activity executed by a service can be defined in the process template.

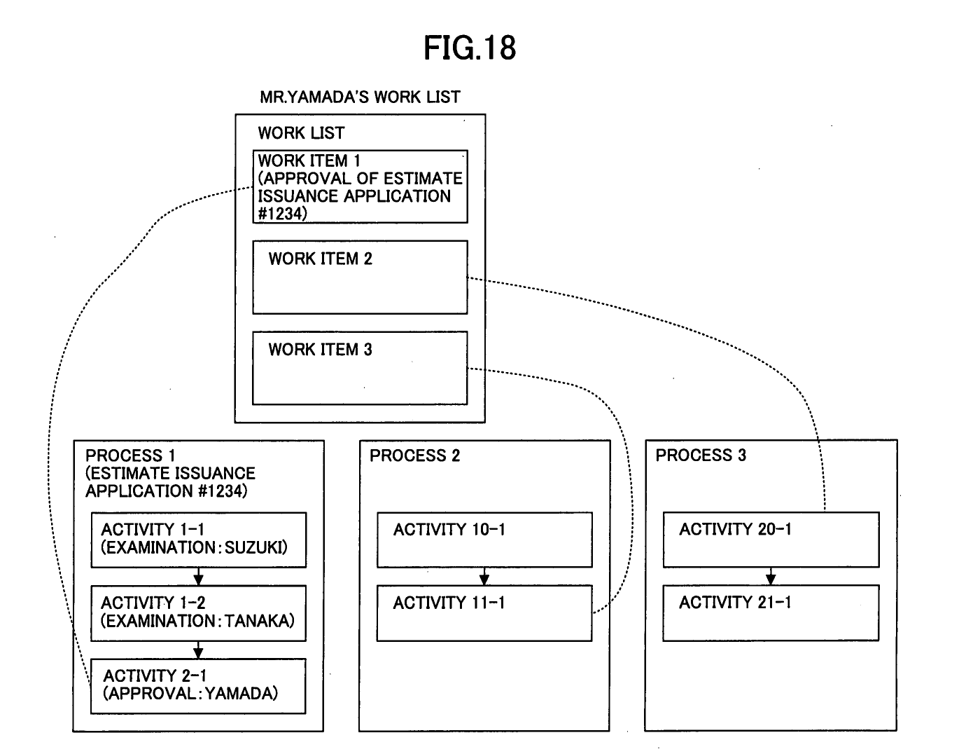

Next, a description is given, with reference to FIG. 18, of the relationship among the work list, the work item, and the activity. FIG. 18 is a diagram for illustrating the relationship among the work list, the work item, and the activity.

Referring to FIG. 18, for instance, the work list of Mr. Yamada, who is a participant in the document flow, includes a list of work items to be executed by Mr. Yamada at this point.

For instance, WORK ITEM 1 corresponds to ACTIVITY 2-1 of PROCESS 1. WORK ITEM 2 corresponds to ACTIVITY 20-1 of PROCESS 3. WORK ITEM 3 corresponds to ACTIVITY 11-1 of PROCESS 2. As described above, an activity without user intervention cannot be a work item. Therefore, such an activity is not included in the work list.

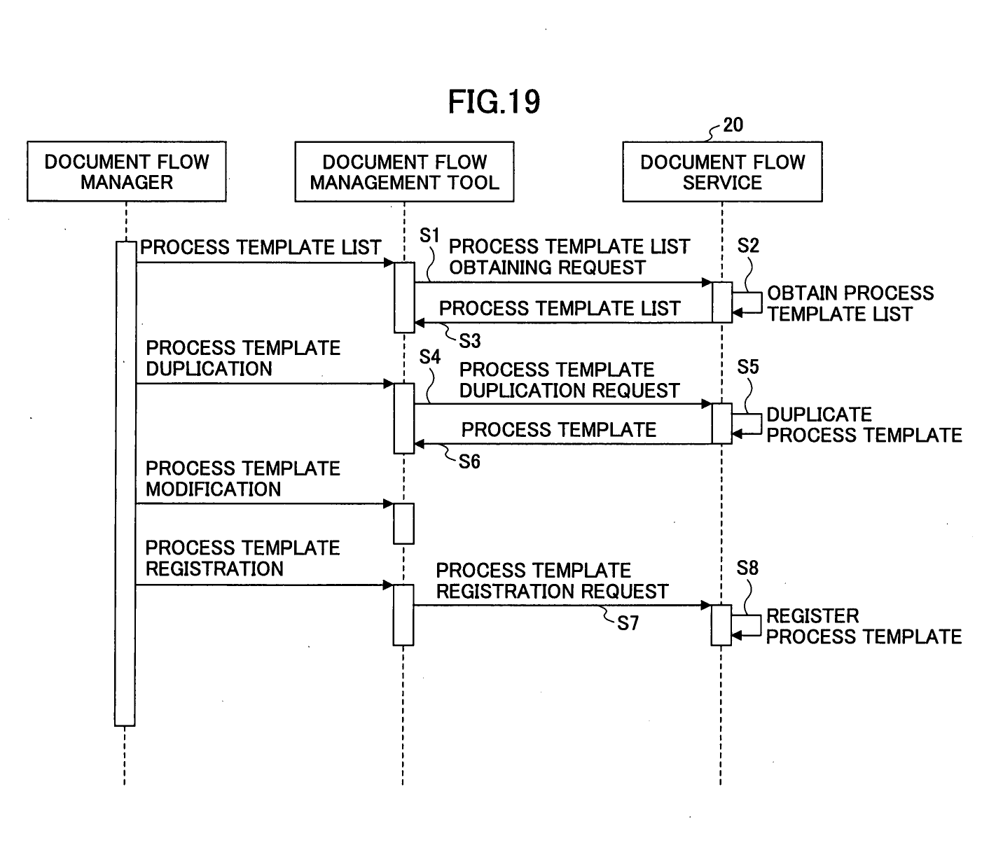

Next, a description is given, with reference to FIG. 19, of a process definition sequence. FIG. 19 is a sequence diagram of process definition.

In step S1 of FIG. 19, the document flow management tool, requested by the document flow manager to obtain a process template list, transmits a request to obtain a process template list (a process template list obtaining request) to the document flow service 20.

In step S2, receiving the process template list obtaining request from the document flow management tool, the document flow service 20 searches the process templates retained in, for instance, the process repository service 24, and obtains a list of corresponding process templates.

In step S3, the document flow service 20, having obtained the list of the corresponding process templates (process template list), transmits the obtained process template list to the document flow management tool.

Obtaining the process template list using the document flow management tool, the document flow manager selects from the list a process template suitable for a purpose, and requests the document flow management tool to obtain a duplicate of the selected process template. Then, in step S4, the document flow management tool, requested by the document flow manager to obtain a duplicate of the selected process template, transmits a request to duplicate the selected process template (a process template duplication request) to the document flow service 20.

In step S5, receiving the process template duplication request from the document flow management tool, the document flow service 20 makes a duplicate of the corresponding process template.

In step S6, the document flow service 20, having made a duplicate of the corresponding process template, transmits the duplicate of the process template to the document flow management tool.

Receiving the duplicate of the process template using the document flow management tool, the document flow manager modifies the received (duplicate) process template, and requests the document flow management tool to register the modified process template. Then, in step S7, the document flow management tool, requested by the document flow manager to register the modified process template, transmits a request to register the modified process template (a process template registration request) to the document flow service 20.

In step S8, receiving the process template registration request from the document flow management tool, the document flow service 20 registers the process template with, for instance, the process repository service 24.

By performing an operation as shown in FIG. 19, the document flow manager can register a new process template with the document flow service 20.

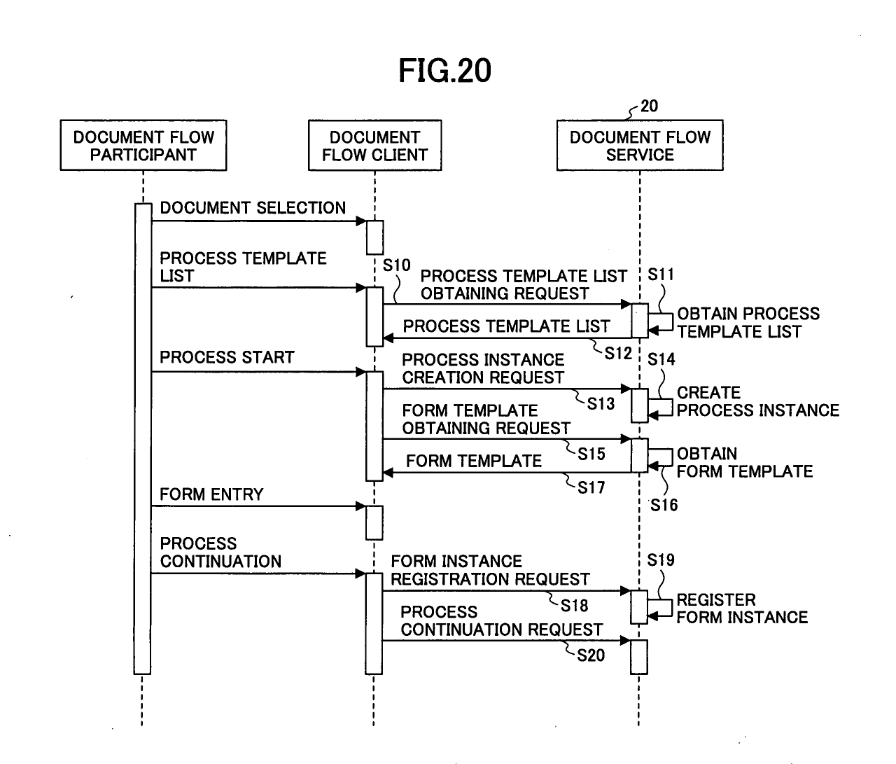

Next, a description is given, with reference to FIG. 20, of a process starting sequence. FIG. 20 is a sequence diagram of process starting according to this embodiment.

Referring to FIG. 20, first, a document flow participant, using the document flow client, selects a document to be the object of the document flow, and requests the document flow client to obtain a process template list. Then, in step S10 of FIG. 20, the document flow client, requested by the document flow participant to obtain a process template list, transmits a process template list obtaining request to the document flow service 20.

In step S1, receiving the process template obtaining request from the document flow client, the document flow service 20 searches the process templates retained in, for instance, the process repository service 24, and obtains a list of corresponding process templates.

In step S12, the document flow service 20, having obtained the list of the corresponding process templates (process template list), transmits the obtained process template list to the document flow client.

Obtaining the process template list using the document flow client, the document flow participant selects from the list a process template suitable for a purpose, and requests the document flow client to start a process. Then, in step S13, the document flow client, requested by the document flow participant to start a process, transmits a request to create a process instance including information on the process template selected by the participant (a process instance creation request) to the document flow service 20.

In step S14, receiving the process instance creation request, the document flow service 20 creates a corresponding process instance.

In step S15, the document flow client, having transmitted the process instance creation request to the document flow service 20, transmits a request to obtain a corresponding form template (a form template obtaining request) to the document flow service 20.

In step S16, receiving the form template obtaining request from the document flow client, the document flow service 20 obtains the corresponding form template from, for instance, the process repository service 24.

In step S17, the document flow service 20, having obtained the corresponding form template, transmits the obtained form template to the document flow client.

Receiving the form template, the document flow client creates a screen based on the received form template. The document flow participant enters, for instance, a comment on the starting of the process on the screen, and requests the document flow client to continue the process.

In step S18, the document flow client, requested by the document flow participant to continue the process, transmits a request to register a form instance including the comment entered by the document flow participant (a form instance registration request) to the document flow service 20.

In step S19, receiving the form instance registration request from the document flow client, the document flow service 20 registers the form instance including the comment entered by the document flow participant with, for instance, the process repository service 24.

In step S20, the document flow client, having transmitted the form instance registration request to the document flow service 20, transmits a request to continue the corresponding process to the document flow service 20.

By performing an operation as shown in FIG. 20, a document flow participant can select a document to be the center of the document flow and start the document flow.

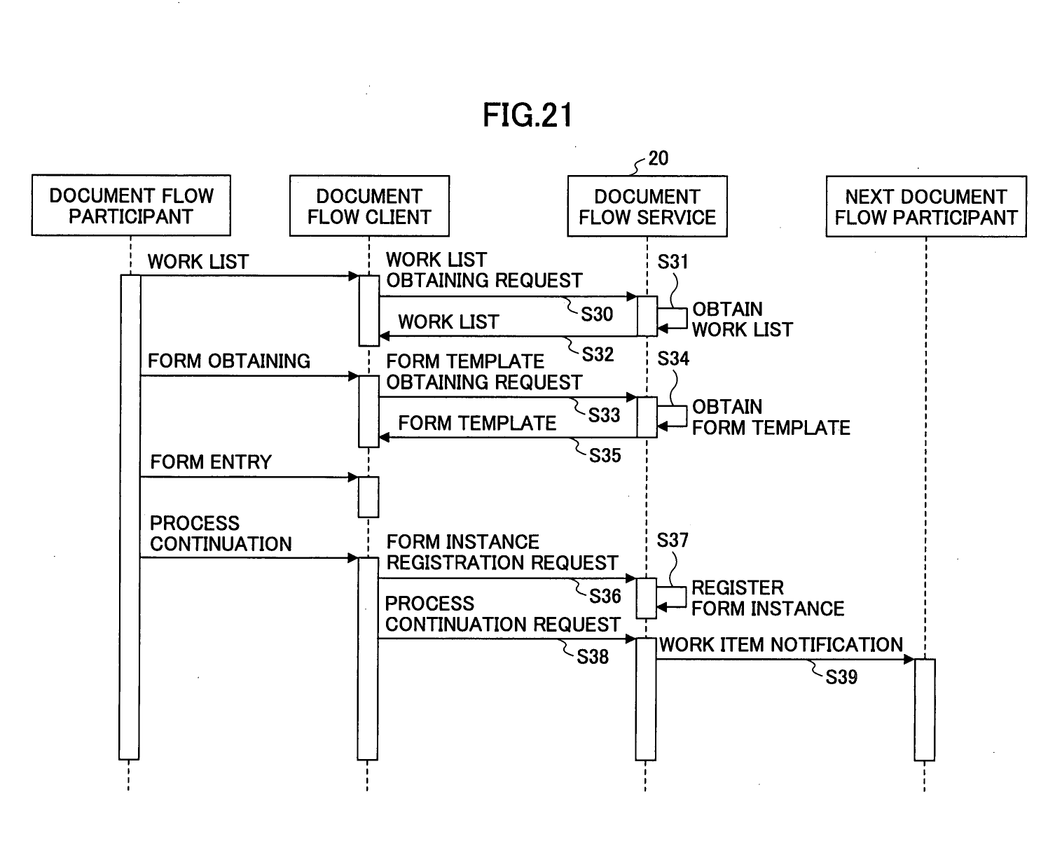

Next, a description is given, with reference to FIG. 21, of a work item execution sequence. FIG. 21 is a sequence diagram for illustrating a first work item execution sequence according to this embodiment. The work items and the work list may be retained constantly by the document flow service 20. Alternatively, the work items and the work list may also be generated temporarily by the document flow server 20 in accordance with an obtaining request from the document flow client when the request is made. However, in the following description, it is assumed for simplification of description that the work items and the work list are constantly retained by the document flow service 20.

Referring to FIG. 21, first, a document flow participant requests the document flow client to obtain a work list. Then, in step S30 of FIG. 21, the document flow client, requested by the document flow participant to obtain a work list, transmits a request to obtain a work list including an identifier identifying the document flow participant (a work list obtaining request) to the document flow service 20.

In step S31, receiving the work list obtaining request, the document flow service 20 obtains a work list including work items to be executed at this point by the document flow participant from, for instance, the process repository service 24 based on the identifier identifying the participant included in the request.

In step S32, the document flow service 20, having obtained the work list including the work items to be executed at this point by the participant, transmits the obtained work list to the document flow client.

Obtaining the work list using the document flow client, the document flow participant selects a work item from the work list, and transmits a request to obtain a corresponding form template (a form template obtaining request) to the document flow client. Then, in step S33, the document flow client, requested to obtain the corresponding form template, transmits the form template obtaining request to the document flow service 20.

In step S34, receiving the form template obtaining request from the document flow client, the document flow service 20 obtains the corresponding form template from, for instance, the process repository service 24.

In step S35, the document flow service 20, having obtained the corresponding form template, transmits the obtained form template to the document flow client.

Receiving the form template, the document flow client creates a corresponding screen based on the received form template. The document flow participant enters, for instance, a comment on examination and approval on the screen, and requests the document flow client to continue the process.

In step S36, the document flow client, requested by the document flow participant to continue the process, transmits a request to register a form instance including the comment entered by the document flow participant (a form instance registration request) to the document flow service 20.

In step S37, receiving the form instance registration request from the document flow client, the document flow service 20 registers the form instance including the comment entered by the document flow participant with, for instance, the process repository service 24.

In step S38, the document flow client, having transmitted the form instance registration request to the document flow service 20, transmits a request to continue the corresponding process (a process continuation request) to the document flow service 20.

In step S39, receiving the process continuation request from the document flow client, the document flow service 20, referring to, for instance, a corresponding process instance, transmits a request to execute a work item to be executed by the next document flow participant (for instance, a request for examination and/or approval) to, for instance, the document flow client of the next document flow participant.

By performing an operation as shown in FIG. 21, a document flow participant can execute a work item to be executed by the document flow participant.

[Second Embodiment]

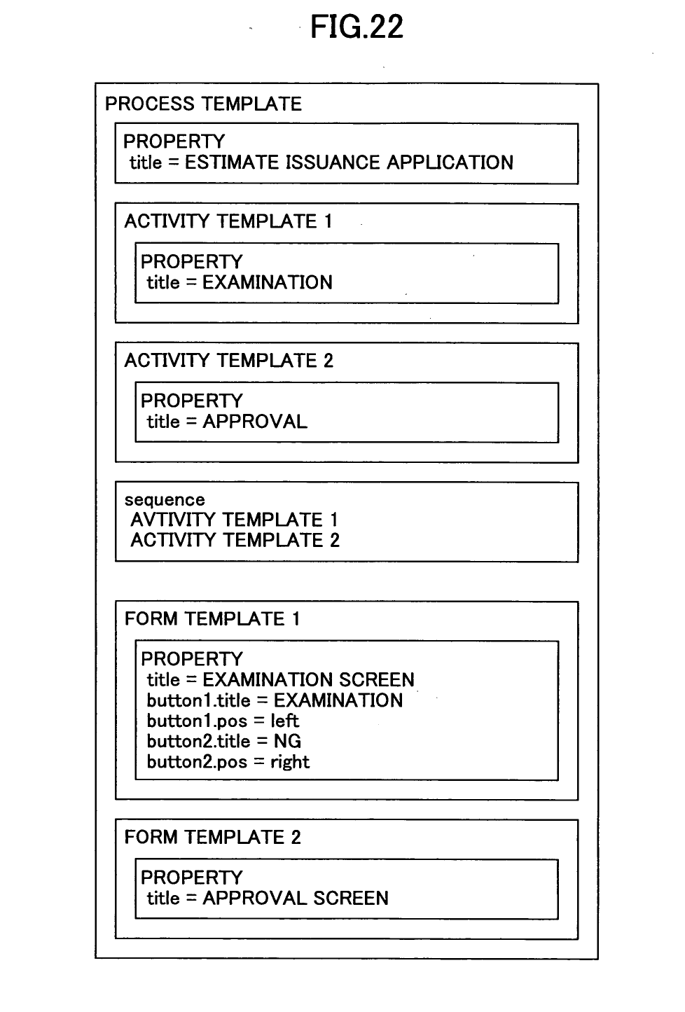

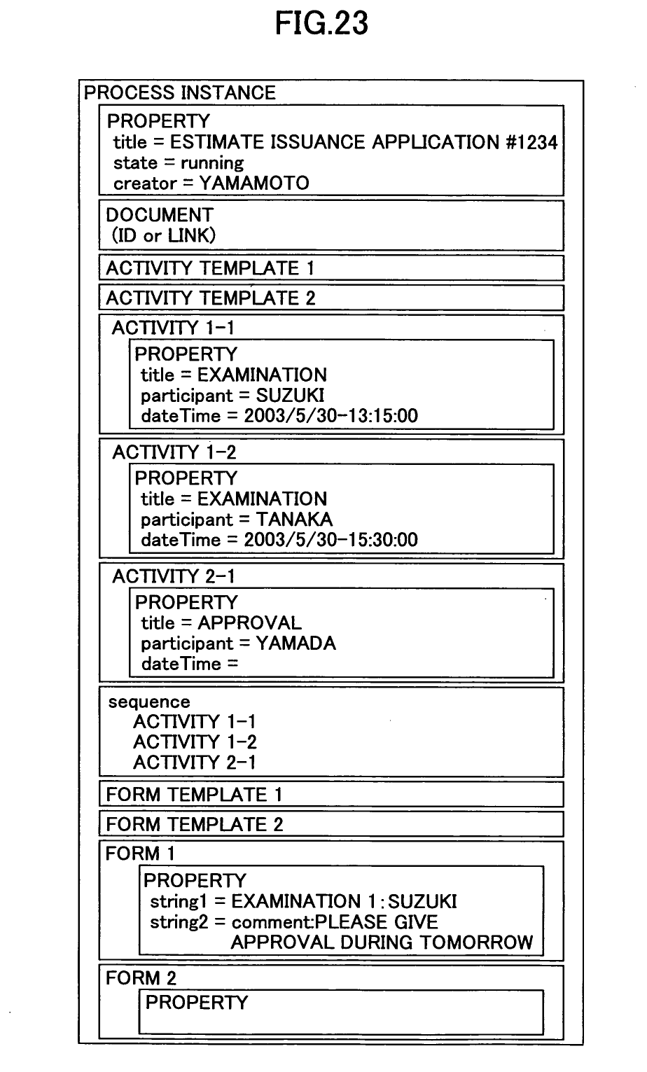

In the first embodiment, the activity templates and/or the activity instances are included in the information item “sequence” as shown in, for instance, FIGS. 10, 11, 13, and 14. Alternatively, the activity templates and/or the activity instances may be provided outside the information item “sequence.” A description is given below, with reference to FIGS. 22 and 23, of the case where the activity templates and/or the activity instances are provided outside the information item “sequence.” In the second embodiment, the difference from the first embodiment is described.

FIG. 22 is a diagram for illustrating a configuration of the process template according to the second embodiment. In contrast to the process template shown in FIG. 10 of the first embodiment, the activity templates are provided outside the information item “sequence” in the process template shown in FIG. 22.

As shown in FIG. 22, an activity template may be provided outside the information item “sequence.”

FIG. 23 is a diagram for illustrating a configuration of the process instance according to the second embodiment. In contrast to the process instance shown in FIG. 11 of the first embodiment, the activity instances are provided outside the information item “sequence” in the process instance shown in FIG. 23.

As shown in FIG. 23, an activity instance may be provided outside the information item “sequence.”

Likewise, the activity templates and/or the activity instances shown in FIGS. 13 and 14 may be provided outside the information item “sequence.”

[Third Embodiment]

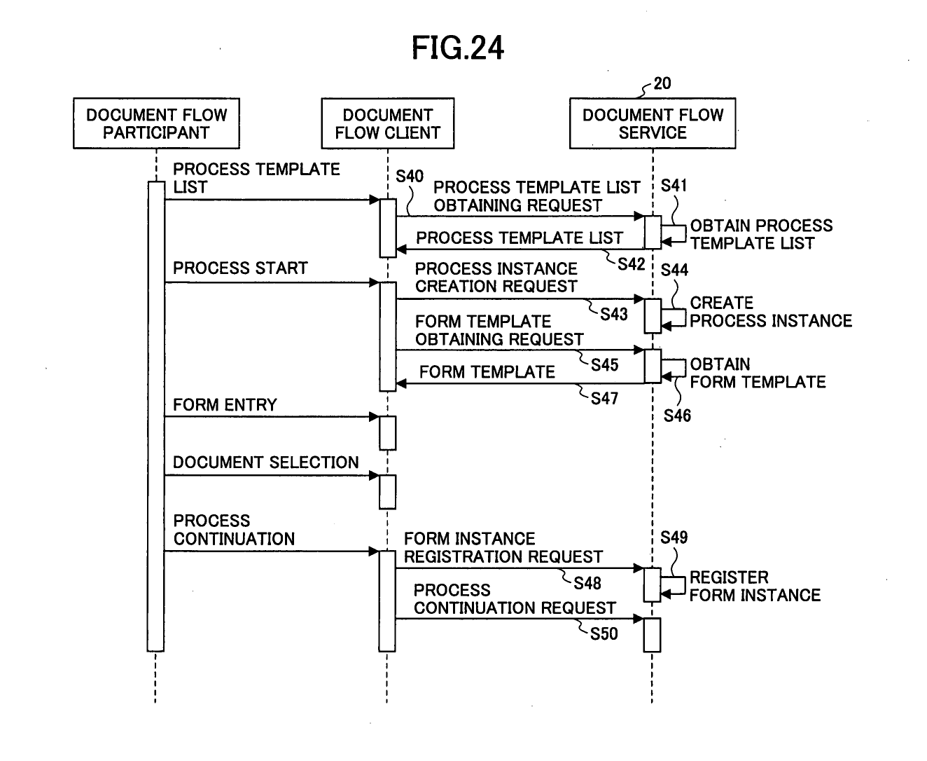

In the above-described embodiments, as shown in FIG. 20 of the first embodiment, a process is started after selecting a document and obtaining a process template list. Alternatively, the document may be selected after obtaining the process template list and starting the process. A description is given below, with reference to FIG. 24, of the case of selecting a document after obtaining a process template list and starting a process. In the third embodiment, the differences from the first and second embodiments are described.

FIG. 24 is a sequence diagram of process starting according to the third embodiment.

Referring to FIG. 24, first, a document flow participant requests the document flow client to obtain a process template list. Then, in step S40 of FIG. 24, the document flow client, requested by the document flow participant to obtain a process template list, transmits a process template list obtaining request to the document flow service 20.

In step S41, receiving the process template list obtaining request from the document flow client, the document flow service 20 searches the process templates retained in, for instance, the process repository service 24, and obtains a list of corresponding process templates.

In step S42, the document flow service 20, having obtained the list of the corresponding process templates (process template list), transmits the obtained process template list to the document flow client.

Obtaining the process template list using the document flow client, the document flow participant selects from the list a process template suitable for a purpose, and requests the document flow client to start a process. Then, in step S43, the document flow client, requested by the document flow participant to start a process, transmits a request to create a process instance including information on the process template selected by the participant (a process instance creation request) to the document flow service 20.

In step S44, receiving the process instance creation request, the document flow service 20 creates a corresponding process instance.

In step S45, the document flow client, having transmitted the process instance creation request to the document flow service 20, transmits a request to obtain a corresponding form template (a form template obtaining request) to the document flow service 20.

In step S46, receiving the form template obtaining request from the document flow client, the document flow service 20 obtains the corresponding form template from, for instance, the process repository service 24.

In step S47, the document flow service 20, having obtained the corresponding form template, transmits the obtained form template to the document flow client.

Receiving the form template, the document flow client creates a screen based on the received form template. The document flow participant enters, for instance, a comment on the starting of the process on the screen, selects a document to be the object of the document flow, and requests the document flow client to continue the process.

In step S48, the document flow client, requested by the document flow participant to continue the process, transmits a request to register a form instance including the comment entered by the document flow participant (a form instance registration request) to the document flow service 20. The form instance registration request includes information on the document to be the object of the document flow selected by the document flow participant. The information on the document may be the ID of the document or link information with respect to the document.

In step S49, receiving the form instance registration request from the document flow client, the document flow service 20 registers the form instance with, for instance, the process repository service 24.

In step S50, the document flow client, having transmitted the form instance registration request to the document flow service 20, transmits a request to continue the corresponding process to the document flow service 20.

As shown in FIG. 24, a document may be selected after obtaining a process template list and starting a process.

[Fourth Embodiment]

In the above-described embodiments, the classes representing the document flow are described as having a relationship as shown in FIG. 8. A document template class may be newly added to the interclass relationship shown in FIG. 8.

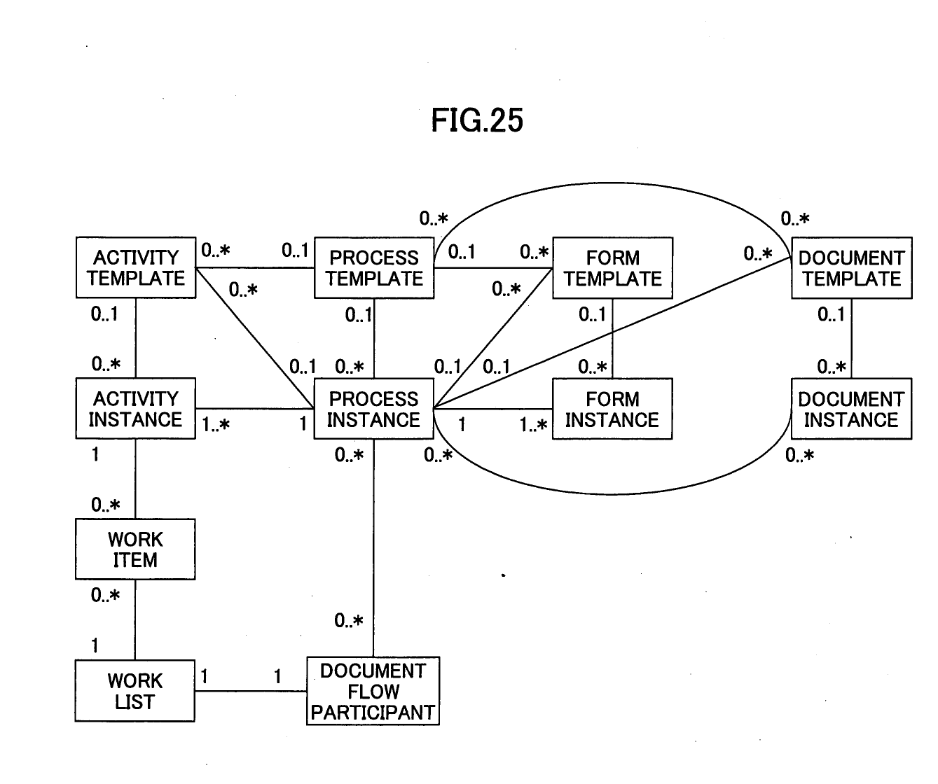

A description is given below, with reference to FIG. 25, of the relationship among the classes representing the document flow. FIG. 25 is a diagram showing an example of the relationship according to the fourth embodiment.

In contrast to the interclass relationship shown in FIG. 8, a document template class is newly added to the interclass relationship shown in FIG. 25. The document template class retains the definition of a document. In the following description, it is assumed that the classes representing the document flow have a relationship as shown in FIG. 25. In the fourth embodiment, the differences from the above-described embodiments are described.

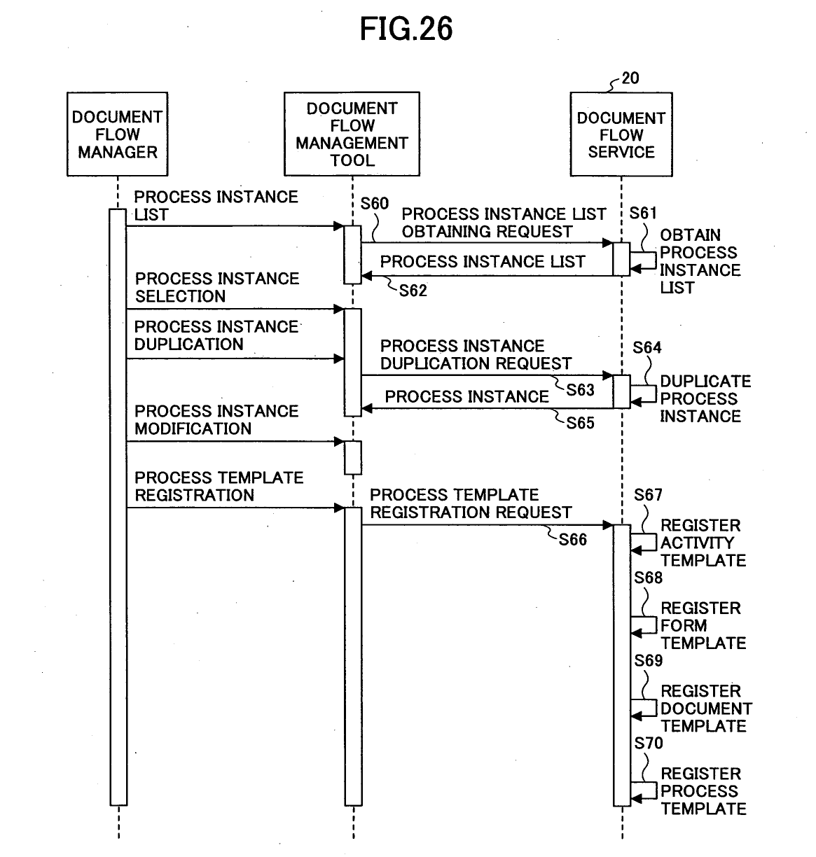

A description is given below, with reference to FIG. 26, of the sequence of registering a process instance as a process template. FIG. 26 is a sequence diagram showing the sequence of registering a process instance as a process template.

In step S60 of FIG. 26, the document flow management tool, requested by the document flow manager to obtain a process instance list, transmits a process instance list obtaining request to the document flow service 20.

In step S61, receiving the process instance list obtaining request from the document flow management tool, the document flow service 20 searches process instances retained in, for instance, the process repository service 24, and obtains a list of corresponding process instances.

In step S62, the document flow service 20, having obtained the list of the corresponding process instances (process instance list), transmits the process instance list to the document flow management tool.

Obtaining the process instance list using the document flow management tool, the document flow manager selects from the list a process instance suitable for a purpose, and requests the document flow management tool to obtain a duplicate of the selected process instance. Then, in step S63, the document flow management tool, requested by the document flow manager to obtain a duplicate of the selected process instance, transmits a request to duplicate the selected process instance (a process instance duplication request) to the document flow service 20.

In step S64, receiving the process instance duplication request from the document management tool, the document flow service 20 makes a duplicate of the corresponding process instance.

In step S65, the document flow service 20, having made a duplicate of the corresponding process instance, transmits the duplicate of the process instance to the document flow management tool.

Obtaining the duplicate of the process instance using the document flow management tool, the document flow manager, for instance, modifies the (duplicate) process instance, and requests the document flow management tool to register the modified process instance as a process template. Then, in step S66, the document flow management tool, requested by the document flow manager to register the modified process instance as a process template, transmits a request to register the modified process instance as a process template (a process template registration request) to the document flow service 20.

In step S67, receiving the process template registration request from the document flow management tool, the document flow service 20 registers an activity instance included in the process instance included in the request with, for instance, the process repository service 24 as an activity template.

Further, in step S68, the document flow service 20 registers a form instance included in the process instance included in the request with, for instance, the process repository service 24 as a form template.

Further, in step S69, the document flow service 20 registers a document instance included in the process instance included in the request with, for instance, the document repository service 25 as a document template.

Further, in step S70, the document flow service 20 registers the process instance included in the request with, for instance, the process repository service 24 as a process template.

The activity template, the form template, and the document template may be registered when the activity instance, the form instance, and the document instance, respectively, are modified as a result of the editing of the process instance by the document flow manager, or when no activity templates, no form templates, and no document templates are registered.

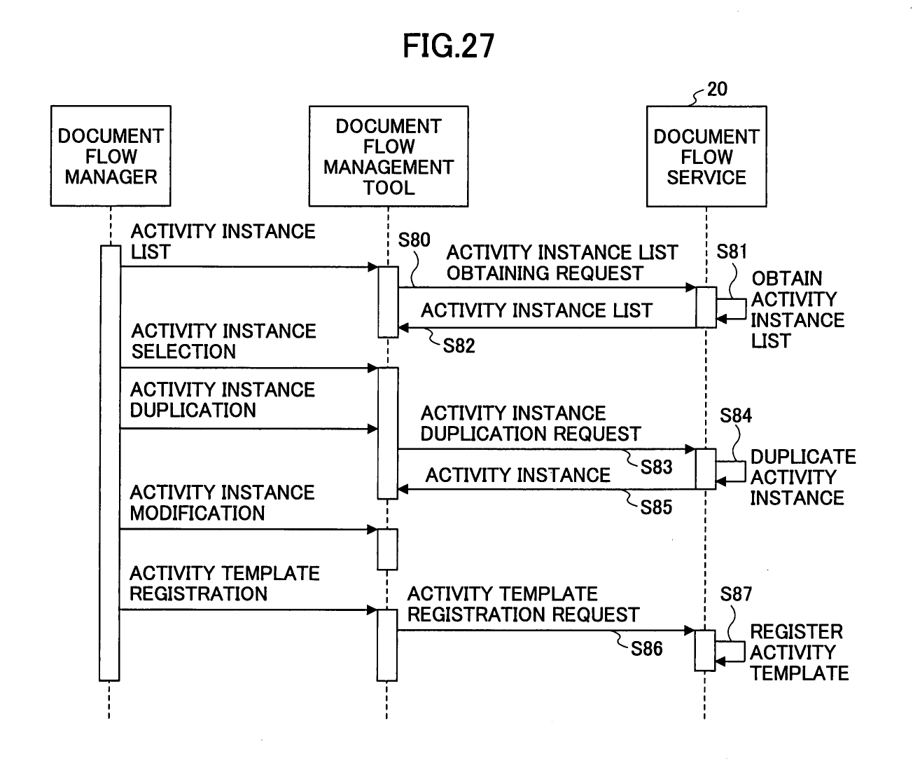

Next, a description is given, with reference to FIG. 27, of the case of registering an activity instance as an activity template. FIG. 27 is a sequence diagram showing the sequence of registering an activity instance as an activity template.

In step S80 of FIG. 27, the document flow management tool, requested by the document flow manager to obtain an activity instance list, transmits an activity instance list obtaining request to the document flow service 20.

In step S81, receiving the activity instance list obtaining request from the document flow management tool, the document flow service 20 searches activity instances retained in, for instance, the process repository service 24, and obtains a list of corresponding activity instances.

In step S82, the document flow service 20, having obtained the list of the corresponding activity instances (activity instance list), transmits the obtained activity instance list to the document flow management tool.

Obtaining the activity instance list using the document flow management tool, the document flow manager selects from the list an activity instance suitable for a purpose, and requests the document flow management tool to obtain a duplicate of the selected activity instance. Then, in step S83, the document flow management tool, requested by the document flow manager to obtain a duplicate of the selected activity instance, transmits a request to duplicate the selected activity instance (an activity instance duplication request) to the document flow service 20.

In step S84, receiving the activity instance duplication request from the document flow management tool, the document flow service 20 makes a duplicate of the corresponding activity instance.

In step S85, the document flow service 20, having made a duplicate of the corresponding activity instance, transmits the duplicate of the activity instance to the document flow management tool.

Obtaining the duplicate of the activity instance using the document flow management tool, the document flow manager, for instance, modifies the obtained (duplicate) activity instance, and requests the document flow management tool to register the modified activity instance as an activity template. Then, in step S86, the document flow management tool, requested by the document flow manager to register the modified activity instance as an activity template, transmits a request to register the modified activity instance as an activity template (an activity template registration request) to the document flow service 20.

In step S87, the document flow service 20 registers the activity instance included in the request with, for instance, the process repository service 24 as an activity template.

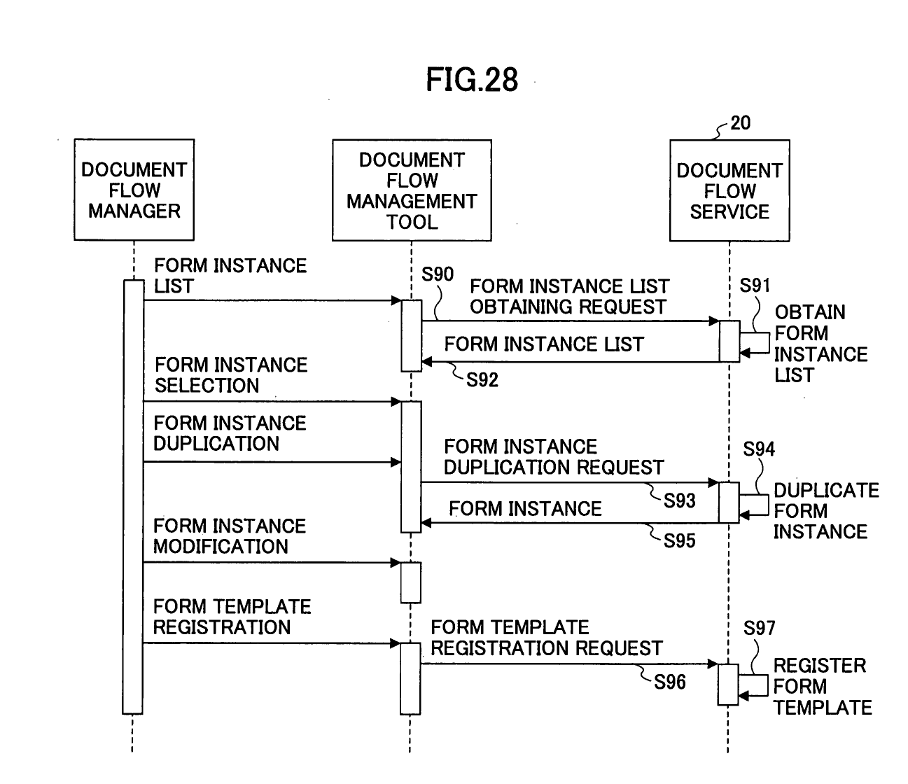

Next, a description is given, with reference to FIG. 28, of the case of registering a form instance as a form template. FIG. 28 is a sequence diagram showing the sequence of registering a form instance as a form template.

In step S90 of FIG. 28, the document flow management tool, requested by the document flow manager to obtain a form instance list, transmits a form instance list obtaining request to the document flow service 20.

In step S91, receiving the form instance list obtaining request from the document flow management tool, the document flow service 20 searches form instances retained in, for instance, the process repository service 24, and obtains a list of corresponding form instances.

In step S92, the document flow service 20, having obtained the list of the corresponding form instances (form instance list), transmits the obtained form instance list to the document flow management tool.

Obtaining the form instance list using the document flow management tool, the document flow manager selects from the list a form instance suitable for a purpose, and requests the document flow management tool to obtain a duplicate of the selected form instance. Then, in step S93, the document flow management tool, requested by the document flow manager to obtain a duplicate of the selected form instance, transmits a request to duplicate the selected form instance (a form instance duplication request) to the document flow service 20.

In step S94, receiving the form instance duplication request from the document flow management tool, the document flow service 20 makes a duplicate of the corresponding form instance.

In step S95, the document flow service 20, having made a duplicate of the corresponding form instance, transmits the duplicate of the form instance to the document flow management tool.

Obtaining the duplicate of the form instance using the document flow management tool, the document flow manager, for instance, modifies the obtained (duplicate) form instance, and requests the document flow management tool to register the modified form instance as a form template. Then, in step S96, the document flow management tool, requested by the document flow manager to register the modified form instance as a form template, transmits a request to register the modified form instance as a form template (a form template registration request) to the document flow service 20.

In step S97, the document flow service 20 registers the form instance included in the request with, for instance, the process repository service 24 as a form template.

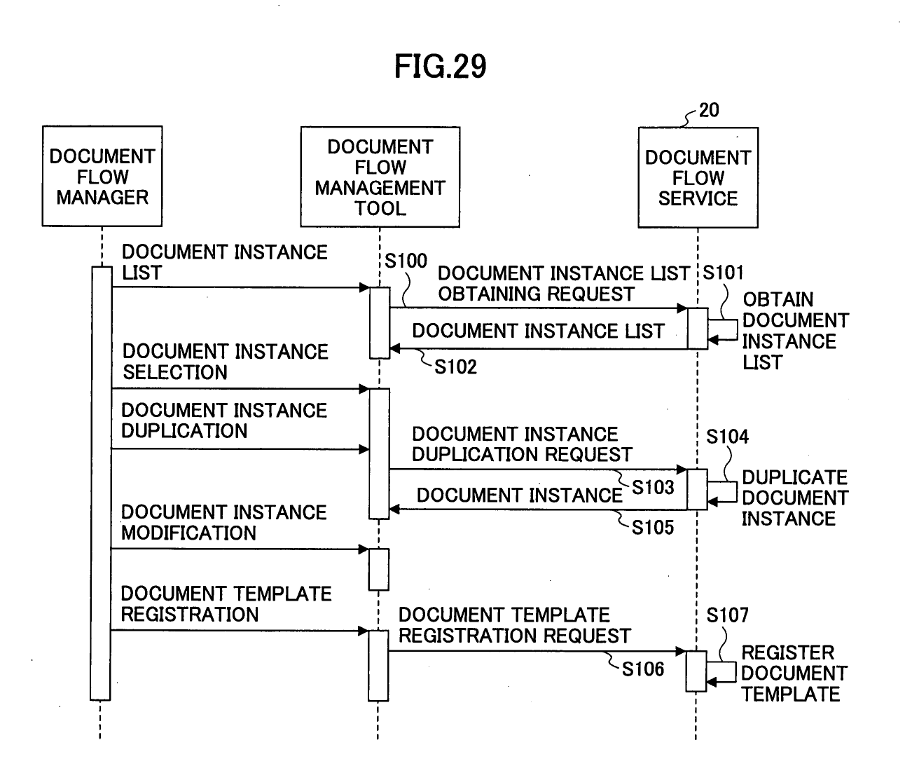

Next, a description is given, with reference to FIG. 29, of the case of registering a document instance as a document template. FIG. 29 is a sequence diagram showing the sequence of registering a document instance as a document template.

In step S100 of FIG. 29, the document flow management tool, requested by the document flow manager to obtain a document instance list, transmits a document instance list obtaining request to the document flow service 20.

In step S101, receiving the document instance list obtaining request from the document flow management tool, the document flow service 20 searches document instances retained in, for instance, the document repository service 25, and obtains a list of corresponding document instances.

In step S102, the document flow service 20, having obtained the list of the corresponding document instances (document instance list), transmits the obtained document instance list to the document flow management tool.

Obtaining the document instance list using the document flow management tool, the document flow manager selects from the list a document instance suitable for a purpose, and requests the document flow management tool to obtain a duplicate of the selected document instance. Then, in step S103, the document flow management tool, requested by the document flow manager to obtain a duplicate of the selected document instance, transmits a request to duplicate the selected document instance (a document instance duplication request) to the document flow service 20.

In step S104, receiving the document instance duplication request from the document flow management tool, the document flow service 20 makes a duplicate of the corresponding document instance.

In step S105, the document flow service 20, having made a duplicate of the corresponding document instance, transmits the duplicate of the document instance to the document flow management tool.

Obtaining the duplicate of the document instance using the document flow management tool, the document flow manager, for instance, modifies the obtained (duplicate) document instance, and requests the document flow management tool to register the modified document instance as a document template. Then, in step S106, the document flow management tool, requested by the document flow manager to register the modified document instance as a document template, transmits a request to register the modified document instance as a document template (a document template registration request) to the document flow service 20.

In step S107, the document flow service 20 registers the document instance included in the request with, for instance, the document repository service 24 as a document template.

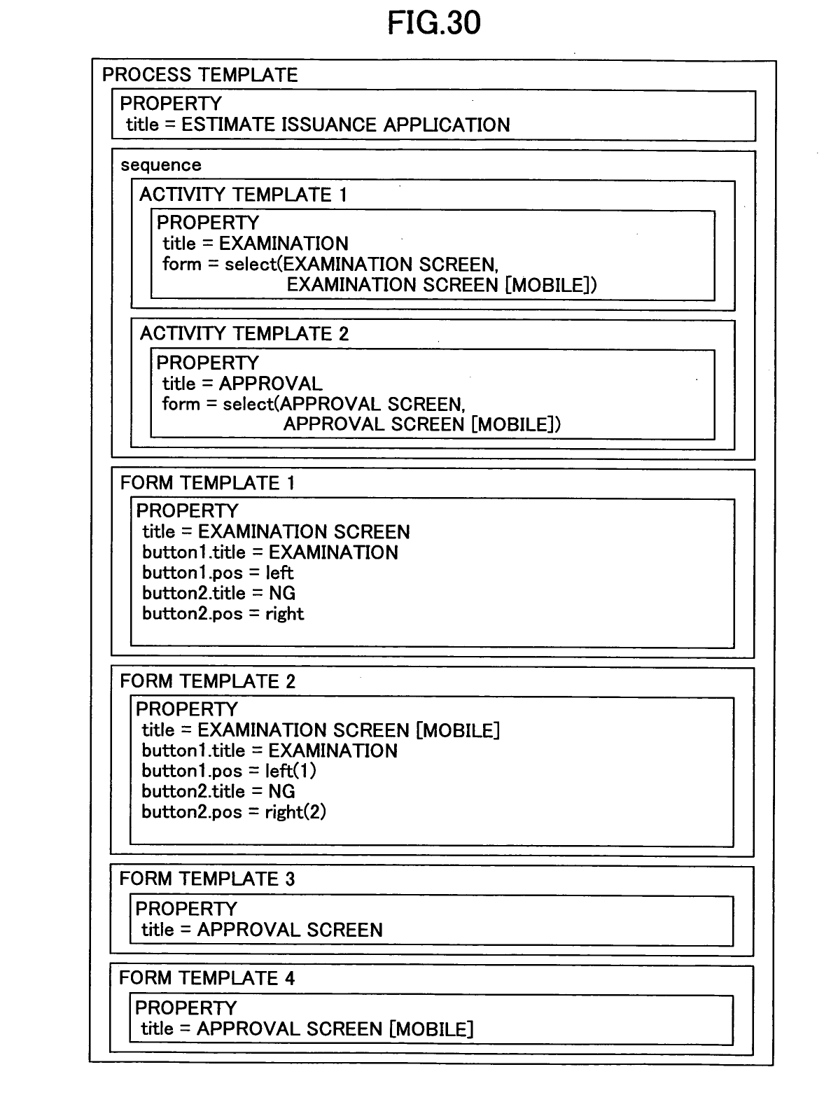

Next, a description is given, with reference to FIG. 30, of the process template according to the fourth embodiment. FIG. 30 is a diagram for illustrating a first configuration of the process template according to the fourth embodiment.

In the process template shown in FIG. 30, ACTIVITY TEMPLATE 1 and ACTIVITY TEMPLATE 2 are included in the information item “sequence,” defining that the activity of examination and the activity of approval are executed in sequence. Further, ACTIVITY TEMPLATE 1 shown in FIG. 30 includes the following property indicating that a form template is to be selected at the time of executing a corresponding activity:
form=select (examination screen, examination screen [mobile]).

Further, ACTIVITY TEMPLATE 2 shown in FIG. 30 includes the following property indicating that a form template is to be selected by a document flow participant at the time of executing a corresponding activity:
form=select (approval screen, approval screen [mobile]).

Further, the process template shown in FIG. 30 includes FORM TEMPLATE 1, FORM TEMPLATE 2, FORM TEMPLATE 3, and FORM TEMPLATE 4. For instance, in FORM TEMPLATE 1, the form of an examination screen for a PC is defined. In FORM TEMPLATE 2, the form of an examination screen for a mobile apparatus such as a cellular phone is defined. In FORM TEMPLATE 3, the form of an approval screen for a PC is defined. In FORM TEMPLATE 4, the form of an approval screen for a mobile apparatus is defined. That is, in the case of FIG. 30, the form templates include basic data for screen creation in a PC and a mobile apparatus.

Using a process template as shown in FIG. 30, the document flow service 20 can obtain, for instance, a form template for an examination screen and a form template for an examination screen [mobile] from, for instance, the process repository service 24 at the time of executing a corresponding activity, so that a document flow participant can select, for instance, the examination screen or the examination screen [mobile] displayed at the time of executing the activity.

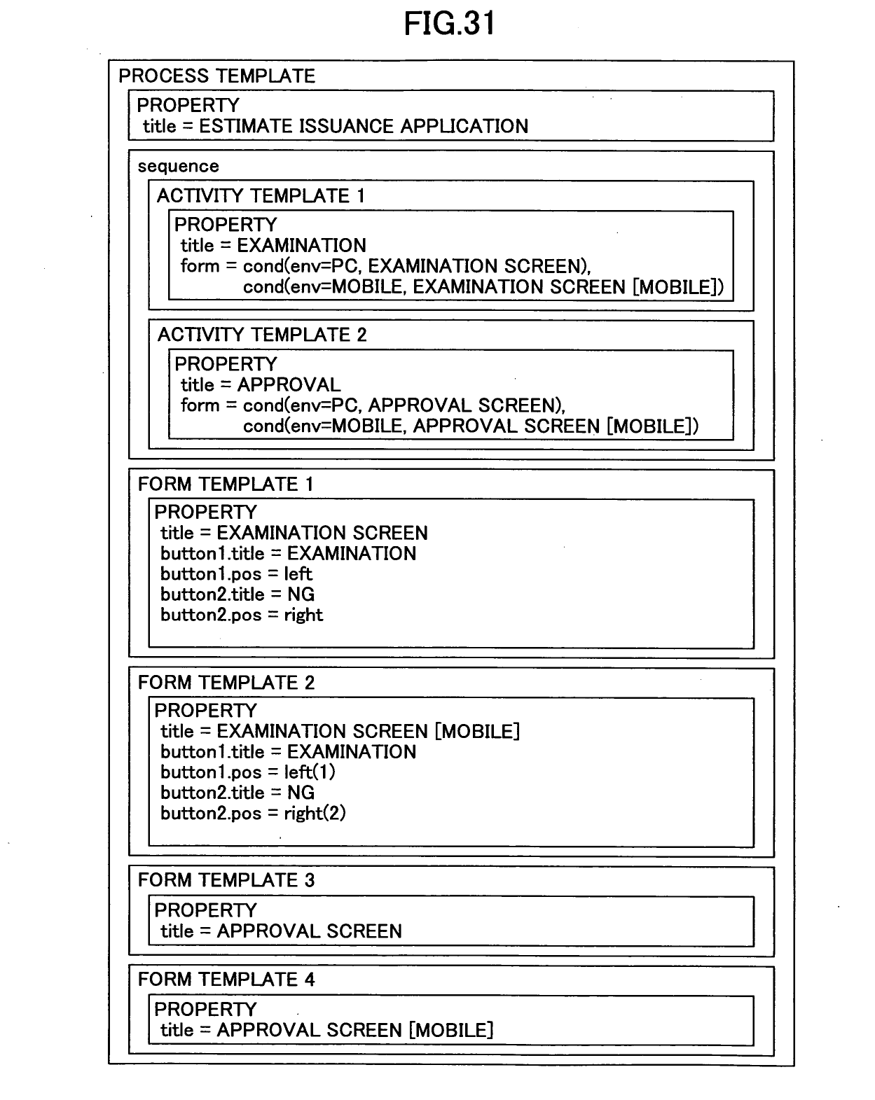

A description is further given, with reference to FIG. 31, of the process template. FIG. 31 is a diagram for illustrating a second configuration of the process template according to the fourth embodiment.

In the process template shown in FIG. 31, ACTIVITY TEMPLATE 1 includes the following property representing conditions for the document flow service 20 selecting a form template at the time of executing a corresponding activity:

$$\begin{matrix}form = cond ( env = PC , examination screen ) \\ = cond ( env = MOBILE , examination screen [ mobile ] ) .\end{matrix}$$

Further, ACTIVITY TEMPLATE 2 includes the following property representing conditions for the document flow service 20 selecting a form template at the time of executing a corresponding activity:

$$\begin{matrix}form = cond ( env = PC , approval screen ) \\ = cond ( env = MOBILE , approval screen [ mobile ] ) .\end{matrix}$$

Using a process template as shown in FIG. 31, the document flow service 20 can select and obtain, for instance, a form template for an examination screen or a form template for an examination screen [mobile] from, for instance, the process repository service 24 based on a condition written as “env=”, and provide the obtained form template to the document flow client at the time of executing a corresponding activity.

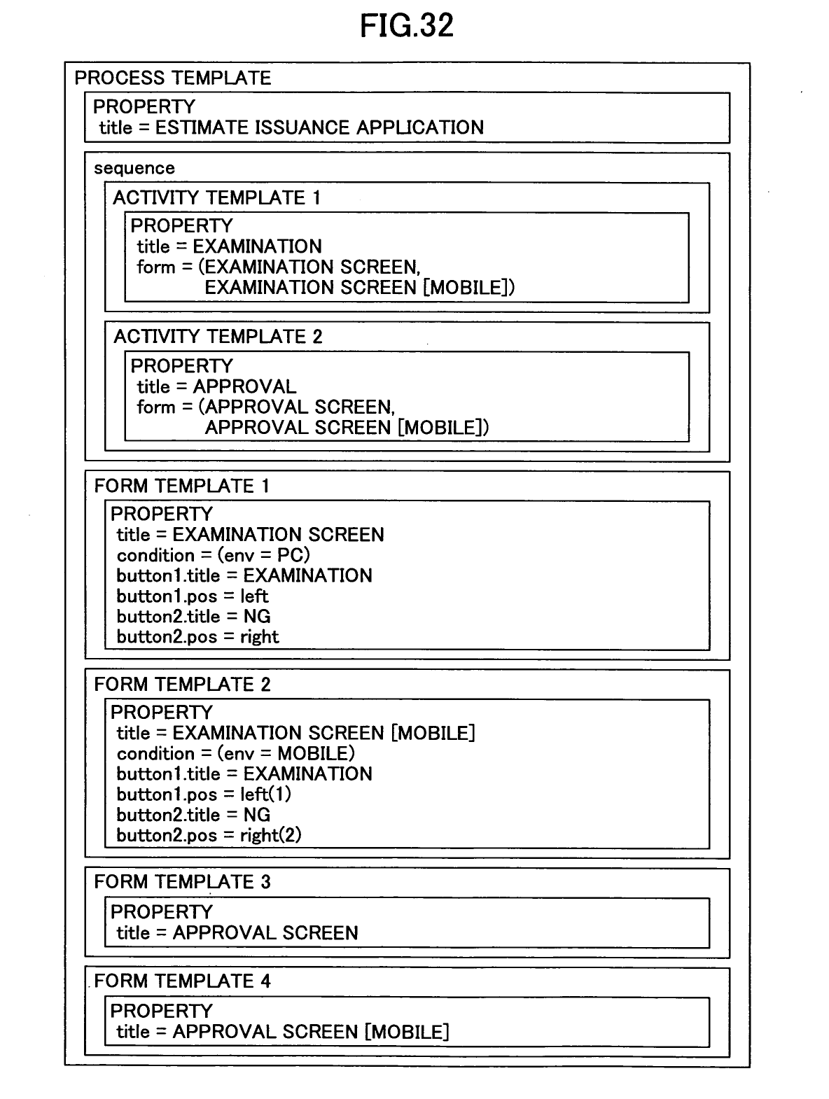

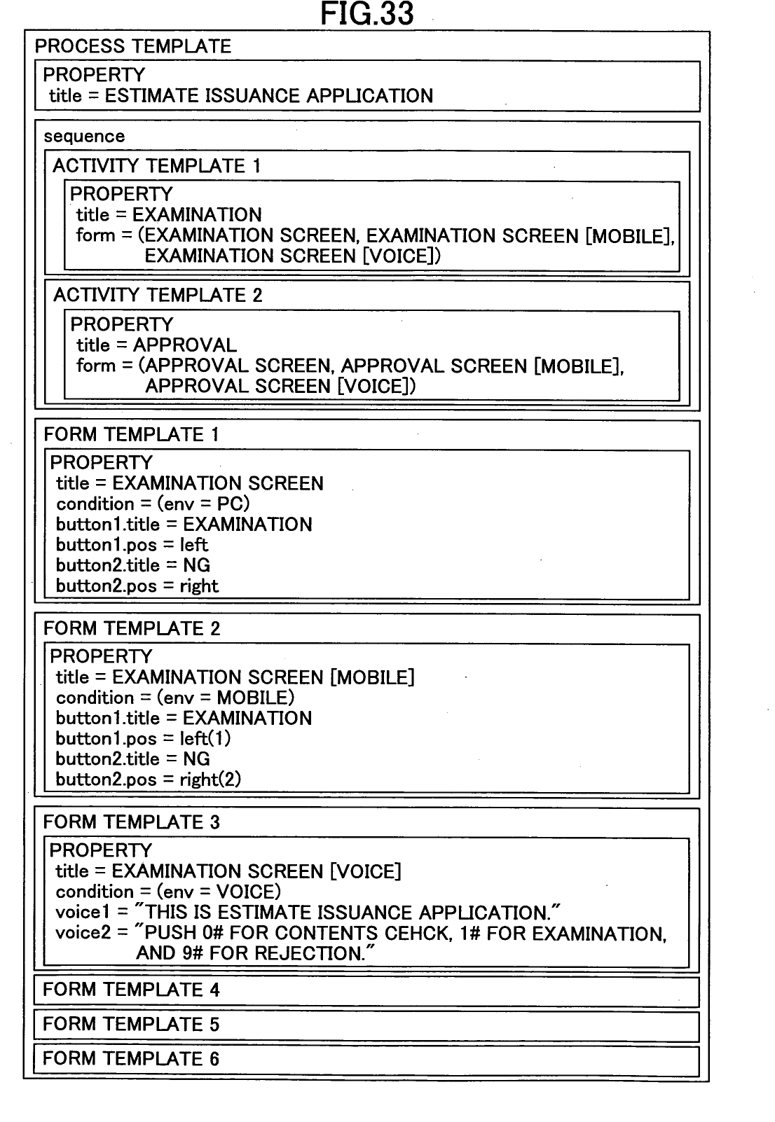

A description is further given, with reference to FIG. 32, of the process template. FIG. 32 is a diagram for illustrating a third configuration of the process template according to the fourth embodiment.

In the process template shown in FIG. 32, ACTIVITY TEMPLATE 1 includes the following property representing candidate form templates:
form=(examination screen, examination screen [mobile]).

Further, ACTIVITY TEMPLATE 2 includes the following property representing candidate form templates:
form=(approval screen, approval screen [mobile]).

Further, FORM TEMPLATE 1 includes the following property representing a condition to be set at the time of executing a corresponding activity:
condition=(env=PC),
   and FORM TEMPLATE 2 includes the following property representing a condition to be set at the time of executing a corresponding activity:
condition=(env=MOBILE).

Using a process template as shown in FIG. 32, the document flow service 20 can select and obtain, for instance, a form template for an examination screen or a form template for an examination screen [mobile] from, for instance, the process repository service 24 based on a condition written as “env=” at the time of selecting and obtaining a corresponding form template, and provide the obtained form template to the document flow client.

A description is further given, with reference to FIG. 33, of the process template. FIG. 33 is a diagram for illustrating a fourth configuration of the process template according to the fourth embodiment.

The process template shown in FIG. 33 includes, for instance, a form template (FORM TEMPLATE 3) that can be handled by only voice. Further, ACTIVITY TEMPLATE 1 includes the following property representing form template candidates:
form=(examination screen, examination screen [mobile], examination screen [voice]).

Further, ACTIVITY TEMPLATE 2 includes the following property representing form template candidates:
form=(approval screen, approval screen [mobile], approval screen [voice]).

Further, FORM TEMPLATE 1 includes the following property representing a condition to be set at the time of executing a corresponding activity:
condition=(env=PC),
   FORM TEMPLATE 2 includes the following property representing a condition to be set at the time of executing a corresponding activity:
condition=(env=MOBILE),
   and FORM TEMPLATE 3 includes the following property representing a condition to be set at the time of executing a corresponding activity:
condition=(env=VOICE).

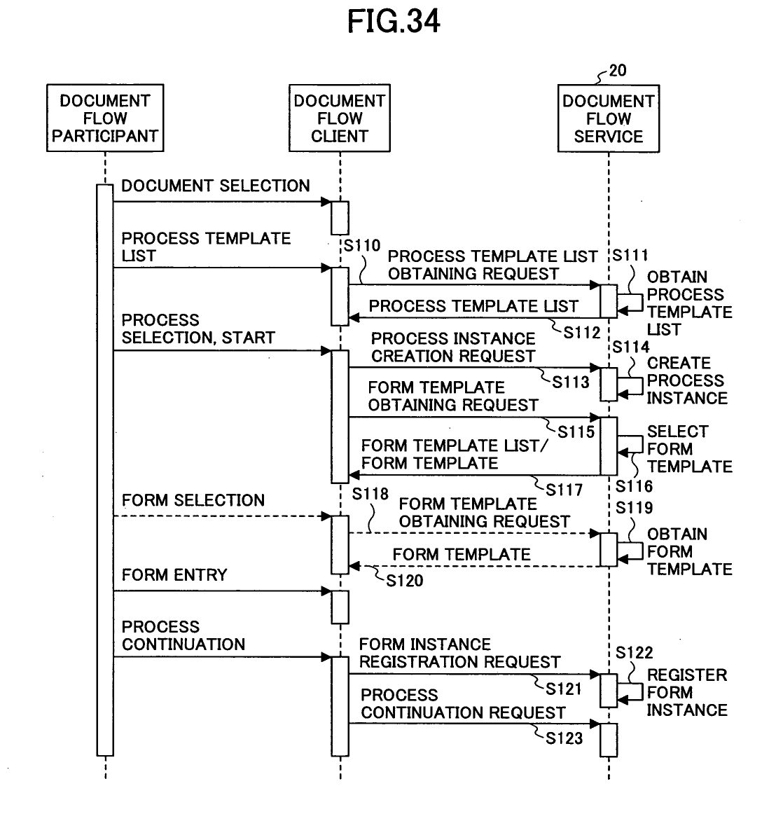

Next, a description is given, with reference to FIG. 34, of a process starting sequence. FIG. 34 is a sequence diagram of process starting according to the fourth embodiment.

Referring to FIG. 34, first, a document flow participant, using the document flow client, selects a document to be the object of the document flow, and requests the document flow client to obtain a process template list. Then, in step S110 of FIG. 34, the document flow client, requested by the document flow participant to obtain a process template list, transmits a process template list obtaining request to the document flow service 20.

In step S111, receiving the process template obtaining request from the document flow client, the document flow service 20 searches the process templates retained in, for instance, the process repository service 24, and obtains a list of corresponding process templates.

In step S112, the document flow service 20, having obtained the list of the corresponding process templates (process template list), transmits the obtained process template list to the document flow client.

Obtaining the process template list using the document flow client, the document flow participant selects from the list a process template suitable for a purpose, and requests the document flow client to start a process. Then, in step S113, the document flow client, requested by the document flow participant to start a process, transmits a request to create a process instance including information on the process template selected by the participant (a process instance creation request) to the document flow service 20.

In step S114, receiving the process instance creation request, the document flow service 20 creates a corresponding process instance.

In step S115, the document flow client, having transmitted the process instance creation request to the document flow service 20, transmits a request to obtain a corresponding form template (a first form template obtaining request) to the document flow service 20.

In step S116, receiving the first form template obtaining request from the document flow client, the document flow service 20 selects (searches out) and obtains the corresponding form template as shown in FIG. 30, 31, 32, or 33 from, for instance, the process repository service 24 based on, for instance, user information and/or an execution environment, namely, for instance, whether the document flow client is a PC or a mobile apparatus, included in the first form template obtaining request.

If multiple form templates are selected and obtained as a result of step S116, in step S117, the document flow service 20 transmits a list of the obtained form templates to the document flow client. On the other hand, if a single form template is selected and obtained as a result of step S116, in step S117, the document flow service 20 transmits the obtained form template to the document flow client.

If, for instance, the document flow client receives the list of the form templates, in step S118, the document flow participant selects a form template from the list, and transmits a request to obtain the selected form template (a second form template obtaining request) to the document flow service 20.

In step S119, receiving the second form template obtaining request from the document flow client, the document flow service 20 obtains the form template selected by the document flow participant from, for instance, the process repository service 24.

In step S120, the document flow service 20, having obtained the form template selected by the document flow participant, transmits the obtained form template to the document flow client.

Obtaining the form template in step S117 or S120, the document flow client creates a screen based on the received form template. The document flow participant enters, for instance, a comment on the starting of the process on the screen, and requests the document flow client to continue the process.

In step S121, the document flow client, requested by the document flow participant to continue the process, transmits a request to register a form instance including the comment entered by the document flow participant (a form instance registration request) to the document flow service 20.

In step S122, receiving the form instance registration request from the document flow client, the document flow service 20 registers the form instance including the comment entered by the document flow participant with, for instance, the process repository service 24.

In step S123, the document flow client, having transmitted the form instance registration request to the document flow service 20, transmits a request to continue the corresponding process to the document flow service 20.

By performing an operation as shown in FIG. 34, a document flow participant can select a document to be the center of the document flow, enter a comment in a form template selected by the participant, and/or by the document flow service 20 in accordance with the attribute information of the participant and/or the execution environment of the document flow client operated by the participant, and start the document flow. The attribute information of the participant includes information such as the section and the title of the participant in the office, or information indicating that the participant is visually impaired.

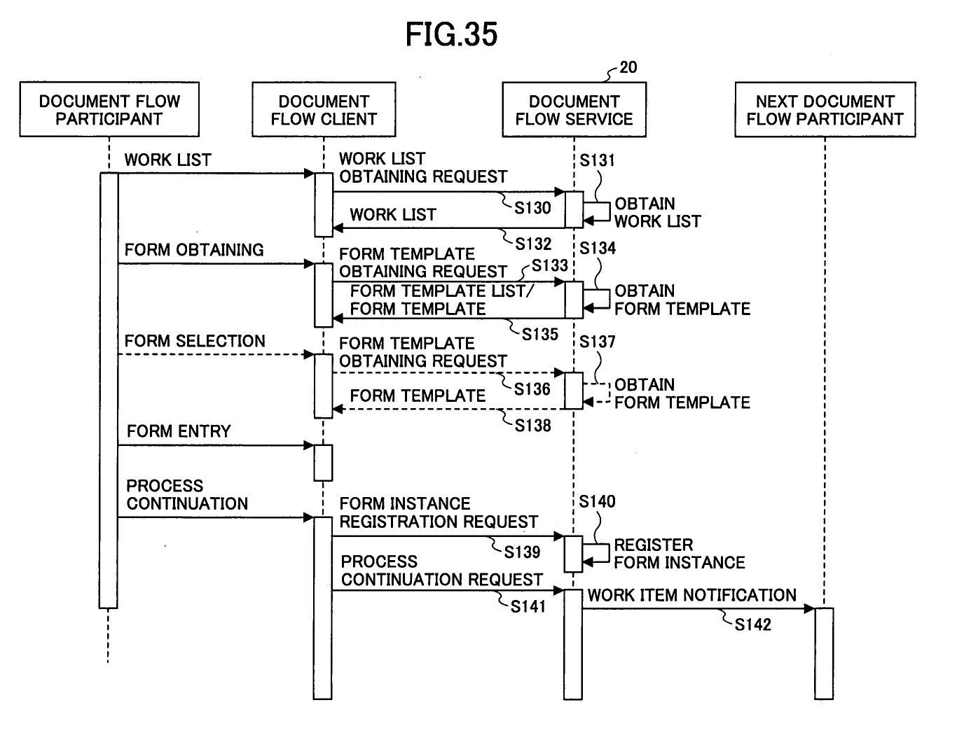

Next, a description is given, with reference to FIG. 35, of a work item execution sequence. FIG. 35 is a sequence diagram for illustrating a work item execution sequence according to the fourth embodiment.

Referring to FIG. 35, first, a document flow participant requests the document flow client to obtain a work list. Then, in step S130 of FIG. 35, the document flow client, requested by the document flow participant to obtain a work list, transmits a request to obtain a work list including an identifier identifying the document flow participant (a work list obtaining request) to the document flow service 20.

In step S131, receiving the work list obtaining request, the document flow service 20 obtains a work list including work items to be executed at this point by the document flow participant from, for instance, the process repository service 24 based on the identifier identifying the participant included in the request.

In step S132, the document flow service 20, having obtained the work list including the work items to be executed at this point by the participant, transmits the obtained work list to the document flow client.

Obtaining the work list using the document flow client, the document flow participant selects a work item from the work list, and transmits a request to obtain a corresponding form template (a first form template obtaining request) to the document flow client. Then, in step S133, the document flow client, requested to obtain the corresponding form template, transmits the first form template obtaining request to the document flow service 20.

In step S134, receiving the first form template obtaining request from the document flow client, the document flow service 20 selects (searches out) and obtains the corresponding form template as shown in FIG. 30, 31, 32, or 33 from, for instance, the process repository service 24 based on, for instance, user information and/or an execution environment, namely, for instance, whether the document flow client is a PC or a mobile apparatus, included in the first form template obtaining request.

If multiple form templates are selected and obtained as a result of step S134, in step S135, the document flow service 20 transmits a list of the obtained form templates to the document flow client. On the other hand, if a single form template is selected and obtained as a result of step S134, in step S135, the document flow service 20 transmits the obtained form template to the document flow client.

If, for instance, the document flow client receives the list of the form templates, in step S136, the document flow participant selects a form template from the list, and transmits a request to obtain the selected form template (a second form template obtaining request) to the document flow service 20.

In step S137, receiving the second form template obtaining request from the document flow client, the document flow service 20 obtains the form template selected by the document flow participant from, for instance, the process repository service 24.

In step S138, the document flow service 20, having obtained the form template selected by the document flow participant, transmits the obtained form template to the document flow client.

Obtaining the form template in step S135 or S138, the document flow client creates a screen based on the received form template. The document flow participant enters, for instance, a comment on the execution of the work item on the screen, and requests the document flow client to continue the process.

In step S139, the document flow client, requested by the document flow participant to continue the process, transmits a request to register a form instance including the comment entered by the document flow participant (a form instance registration request) to the document flow service 20.

In step S140, receiving the form instance registration request from the document flow client, the document flow service 20 registers the form instance including the comment entered by the document flow participant with, for instance, the process repository service 24.

In step S141, the document flow client, having transmitted the form instance registration request to the document flow service 20, transmits a request to continue the corresponding process (a process continuation request) to the document flow service 20.

In step S142, receiving the process continuation request from the document flow client, the document flow service 20, referring to, for instance, a corresponding process instance, transmits a request to execute a work item to be executed by the next document flow participant (for instance, a request for examination and/or approval) to, for instance, the document flow client of the next document flow participant.

By performing an operation as shown in FIG. 35, a document flow participant can enter a comment in a form template selected by the participant, and/or by the document flow service 20 in accordance with the attribute information of the participant and/or the execution environment of the document flow client operated by the participant, and execute a work item to be executed by the document flow participant.

[Fifth Embodiment]

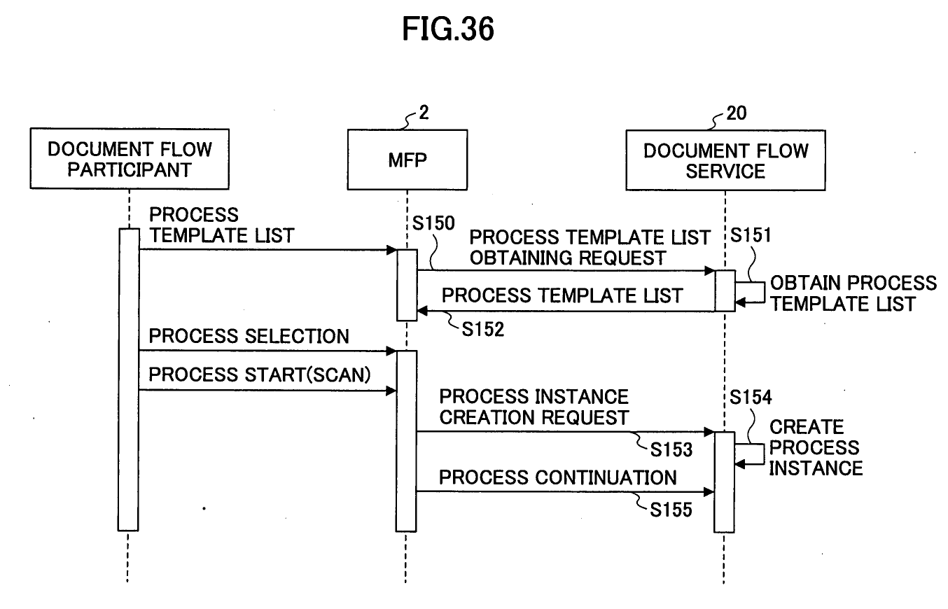

Next, a description is given, with reference to FIG. 36, of a fifth embodiment of the present invention. The fifth embodiment shows the starting of a process in the case where the MFP 2 is employed as a document flow client. FIG. 36 is a sequence diagram of process starting according to the fifth embodiment.

Referring to FIG. 36, first, a document flow participant requests the MFP 2 to obtain a process template list using, for instance, the operations panel 1310 of the MFP 2. Then, in step S150 of FIG. 36, the MFP 2, requested by the document flow participant to obtain a process template list, transmits a process template list obtaining request to the document flow service 20.

In step S151, receiving the process template list obtaining request from the MFP 2, the document flow service 20 searches the process templates retained in, for instance, the process repository service 24, and obtains a list of corresponding process templates.

In step S152, the document flow service 20, having obtained the list of the corresponding process templates (process template list), transmits the obtained process template list to the MFP 2.

Obtaining the process template list using the MFP 2, the document flow participant selects a process template suitable for a purpose from the process template list displayed on, for instance, the operations panel 1310 of the MFP 2, reads a document to be the object of the document flow with the scanner 1202, and requests the MFP 2 to start a process. Then, in step S153, the MFP 2, requested by the document flow participant to start a process, transmits a request to create a process instance including information on the process template selected by the participant and information on the document (a process instance creation request) to the document flow service 20.

In step S154, receiving the process instance creation request, the document flow service 20 creates a corresponding process instance.

Further, in step S155, the MFP 2, having transmitted the process instance creation request to the document flow service 20, transmits a request to continue the corresponding process to the document flow service 20.

By performing an operation as shown in FIG. 36, a document flow participant can read a document to be the center of the document flow with a scanner, and start the document flow.

The present invention is not limited to the specifically disclosed embodiments, and variations and modifications may be made without departing from the scope of the present invention.

The present application is based on Japanese Priority Patent Applications No. 2003-197852, filed on Jul. 16, 2003, and No. 2004-191381, filed on Jun. 29, 2004, the entire contents of which are hereby incorporated by reference.

1. A workflow management apparatus for managing one or more document-related workflows, wherein the document-related workflows are managed by an object-oriented model,
the object-oriented model including:
a process instance class defining one of the document-related workflows;
an activity instance class defining one of steps of the document-related workflows; and
a form instance class defining one of user interfaces employed in executing the steps of the document-related workflows.

2. The workflow management apparatus as claimed in claim 1, wherein multiplicity between the process instance class and the form instance class is greater than or equal to 1:1 in the object-oriented model.

3. The workflow management apparatus as claimed in claim 1, wherein multiplicity between the process instance class and the activity instance class is greater than or equal to 1:1 in the object-oriented model.

4. The workflow management apparatus as claimed in claim 1, wherein the object-oriented model further includes a process template class defining a template of the document-related workflows.

5. The workflow management apparatus as claimed in claim 4, further comprising:
a process management part configured to manage the document-related workflows, the process management part being configured to cause one of the document-related workflows to be the template of the document-related workflows in response to a request.

6. The workflow management apparatus as claimed in claim 1, wherein the object-oriented model further includes an activity template class defining a template of the steps of the document-related workflows.

7. The workflow management apparatus as claimed in claim 6, further comprising:
a process management part configured to manage the document-related workflows, the process management part being configured to cause one of the steps of the document-related workflows to be the template of the steps of the document-related workflows in response to a request.

8. The workflow management apparatus as claimed in claim 1, wherein the object-oriented model further includes a form template class defining a template of the user interfaces employed in executing the steps of the document-related workflows.

9. The workflow management apparatus as claimed in claim 8, further comprising:
a process management part configured to manage the document-related workflows, the process management part being configured to cause one of the user interfaces employed in executing the steps of the document-related workflows to be the template of the user interfaces in response to a request.

10. The workflow management apparatus as claimed in claim 1, wherein the object-oriented model further includes a work item class defining one or more of the steps of the document-related workflows, the one or more of the steps of the document-related workflows being to be executed by a participant in the document-related workflows at a predetermined point.

11. The workflow management apparatus as claimed in claim 1, wherein the object-oriented model further includes a work list class defining a list of one or more of the steps of the document-related workflows, the one or more of the steps of the document-related workflows being to be executed by a participant in the document-related workflows at a predetermined point.

12. The workflow management apparatus as claimed in claim 1, wherein the object-oriented model further includes a document instance class defining one of documents to which the document-related workflows are related.

13. The workflow management apparatus as claimed in claim 1, wherein the object-oriented model further includes a document template class defining a template of documents to which the document-related workflows are related.

14. The workflow management apparatus as claimed in claim 13, further comprising:
a process management part configured to manage the document-related workflows, the process management part being configured to cause one of the documents to be the template of the documents in response to a request.

15. The workflow management apparatus as claimed in claim 1, further comprising:
a process management part configured to manage the document-related workflows, the process management part being configured to select one of templates of the user interfaces employed in executing the steps of the document-related workflows in response to a request from a terminal of a participant in the document-related workflows.

16. The workflow management apparatus as claimed in claim 15, wherein the process management part selects the one of the templates of the user interfaces based on at least one of an execution environment of the terminal of the participant and an attribute of the participant.

17. A method of managing one or more document-related workflows, comprising the steps of:
(a) selecting a template of a user interface in response to a request from a terminal of a participant in the document-related workflows, the user interface being employed when the participant executes one of steps of the document-related workflows; and
(b) transmitting the template of the user interface selected in said step (a) to the terminal of the participant.

18. The method as claimed in claim 17, wherein said step (a) selects the template of the user interface based on at least one of an execution environment of the terminal of the participant and an attribute of the participant.

19. The method as claimed in claim 17, further comprising the step of (c) registering one of the document-related workflows as a template of the document-related workflows in response to a request from the terminal of the participant.

20. The method as claimed in claim 17, further comprising the step of (c) registering one of the steps of the document-related workflows as a template of the steps of the document-related workflows in response to a request from the terminal of the participant.

21. The method as claimed in claim 17, further comprising the step of (c) registering one of user interfaces employed in executing the steps of the document-related workflows as a template of the user interfaces in response to a request from the terminal of the participant.

22. The method as claimed in claim 17, further comprising the step of (c) registering one of documents to which the document-related workflows are related as a template of the documents in response to a request from the terminal of the participant.

23. A computer-readable recording medium storing a program for causing a computer to execute a method of managing one or more document-related workflows, the method comprising the steps of:
(a) selecting a template of a user interface in response to a request from a terminal of a participant in the document-related workflows, the user interface being employed when the participant executes one of steps of the document-related workflows; and
(b) transmitting the template of the user interface selected in said step (a) to the terminal of the participant.
